(19) United States
(12) Patent Application Publication
(10) Pub. No.: US 2022/0270018 A1
(43) Pub. Date: Aug. 25, 2022

(54) SYSTEMS AND METHODS FOR FEEDBACK AND EVALUATION

(71) Applicant: Avant S. C., Milwaukee, WI (US)

(72) Inventor: Kristin Molinaroli, Milwaukee, WI (US)

(21) Appl. No.: 17/668,274

(22) Filed: Feb. 9, 2022

Related U.S. Application Data
(63) Continuation-in-part of application No. 16/262,702, filed on Jan. 30, 2019.
(60) Provisional application No. 62/635,340, filed on Feb. 26, 2018.

(51) Int. Cl. G06Q 10/06; G01S 19/14

(52) U.S. Cl. CPC G06Q 10/06398; G01S 19/14

(57) ABSTRACT

Systems and methods may provide feedback and evaluation on the progress of a learner toward learner-defined goals. Inactive raters may be identified and inactivity alerts may be generated and sent to corresponding users. Goal ratings with observation notes may be identified and observation alerts may be generated and sent to corresponding users. Goal ratings having a rating differential that exceeds a threshold may be identified and delta alerts may be generated and sent to corresponding users. Sustained progress toward goals may be identified and progress alerts may be generated and sent to corresponding users. Average goal ratings for each of a set of corresponding categories may be identified for defined norm groups. Charts may be generated and displayed that provide a comparison between average learner goal ratings over a time segment and the performance of a selected norm group in a corresponding category.

### CROSS-REFERENCE TO RELATED APPLICATIONS

This application is a continuation-in-part of U.S. patent application Ser. No. 16/262,702 entitled “SYSTEMS AND METHODS FOR FEEDBACK AND EVALUATION” and filed on Jan. 30, 2019, which claims priority to U.S. Provisional Application No. 62/635,340, filed Feb. 26, 2018, which is incorporated by reference in its entirety for all purposes.

### FIELD OF THE INVENTION

This disclosure relates to the field of systems and methods for feedback and evaluation. Customized electronic alerts are automatically generated and sent to client computer devices associated with user accounts of different classes of users based on various factors related to feedback and evaluation provided for a subset of the users.

### BACKGROUND

In many traditional professional environments, the main source of performance feedback, evaluation, and goal-setting for any given employee may come from annual or semi-annual reviews. However, this traditional system is lacking in several key ways.

First, many businesses and organizations may progress too quickly for annual or semi-annual goals to remain static and still be effective. For example, dynamic industries such as those related to software and emerging technologies may need to regularly revise goals as new competitors emerge, technology changes, or regulations shift. Failure to regularly revise goals of both the company and individual employees may risk steering an organization off course.

Second, when only annual or semi-annual reviews are performed, supervisors may wait too long to give performance feedback. For example, a supervisor may wait until an annual review to disclose to an employee that the supervisor was disappointed with the employee's performance on a project that occurred several months prior, effectively surprising the employee without having given the employee an opportunity to improve. From another perspective, employees that are performing above expectations may disengage when not given reasonably frequent acknowledgement of their effort and superior work product. It is therefore important for employees to regularly be informed of where they stand and whether their performance aligns with or exceeds the expectations of the organization. As another example, annual reviews may slow the learning cycle of an employee. An employee may be capable of performing at an above-average level with training, coaching, or other learning opportunities, but may be performing at or below the average level due to lack of such learning opportunities. With annual performance reviews, a supervisor may go several months without recognizing the employee's need for these learning opportunities, which may interrupt the learning cycle of the employee such that time that could have been spent improving that employee's performance via learning is instead wasted while the employee is not receiving the learning opportunities they need to succeed.

Finally, annual or semi-annual reviews may impede the growth and development of employees because, as with the above example, opportunities to improve performance and to reward good performance may be lost due to feedback being withheld for up to six months or a year. As a result, time during the reviews that do occur may be wasted dwelling on dated performance incidents, which could instead have been spent focusing on future development of the employee. These wasted opportunities to foster employee growth and development may even damage the long-term engagement of the employee.

### SUMMARY OF THE INVENTION

The present invention provides systems and methods comprising one or more server hardware computing devices or client hardware computing devices, communicatively coupled to a network, and each comprising at least one processor executing respectively specific computer-executable instructions within a memory that, when executed, cause the system to receive, with a client device, customized alerts related to various factors corresponding to the rating of specific goals of a learner by a rater or by the learner.

An inactivity alert may be generated at a server device and sent to one or more client devices linked to (e.g., associated with) user accounts of a learner, a reviewer, and/or a coach. The inactivity alert may be generated and sent by the server device in response to the server device determining that an amount of time exceeding a predetermined inactivity threshold value has passed since the last time the learner was rated on a specific goal by a rater (e.g., indicating that the rater has been idle).

An observation alert may be generated at a server device and sent to one or more client devices linked to (e.g., associated with) user accounts of a learner and/or a coach. The observation alert may be generated and sent by the server device in response to the server device determining that an observation note has been submitted along with a goal rating for a goal of the learner.

A delta alert may be generated at a server device and sent to one or more client devices linked to (e.g., associated with) user accounts of a learner and/or a coach. The delta alert may be generated and sent by the server device in response to the server device determining that a rating differential exceeding a predefined delta threshold value exists between goal ratings submitted by the learner and goal ratings submitted by one or more raters over a predefined time period.

A progress alert may be generated at a server device and sent to one or more client devices linked to (e.g., associated with) user accounts of a learner, a reviewer, and/or a coach. The progress alert may be generated and sent by the server device in response to the server device identifying a goal for which progress has been sustained above a predefined progress threshold value for more than a predefined progress assessment time period.

One or more charts may be generated by the server device and displayed by one or more client devices linked to (e.g., associated with) the user account of a learner. Each chart may depict a comparison between the learner's performance for a goal of the learner and the performance of a selected norm group for a predefined category that corresponds to the goal of the learner. The server device (e.g., a processor thereof) may calculate a mean and a standard deviation of goal ratings (e.g., retrieved from a database stored on a memory of the server device) across a selected time segment, the goal ratings corresponding to the predefined category and the selected norm group. The calculated mean and standard deviation may be used as a basis for generating one of the displayed charts. For example, the chart may be divided into multiple sections, with a given section corresponding to a goal rating range that is bounded based on the calculated mean and standard deviation. The learner's performance for the goal may be quantified as an average of goal ratings submitted by raters for the goal over the selected time segment and may be depicted as an indicator on the chart.

The above features and advantages of the present invention will be better understood from the following detailed description taken in conjunction with the accompanying drawings.

### BRIEF DESCRIPTION OF THE DRAWINGS

FIG. 1 illustrates a system level block diagram showing the interaction between one or more client computer systems and one or more servers communicatively coupled via an electronic communications network, in accordance with an embodiment.

FIG. 2 illustrates a system level block diagram for a computer system that may correspond to any of the individual client computing devices or servers of the network 100 shown in FIG. 1, in accordance with an embodiment.

FIG. 3 is a diagram of an illustrative process flow that may be performed to generate and send one or more customized inactivity alerts in response to identifying an idle rater, in accordance with an embodiment.

FIG. 4 shows an illustrative graphical user interface that displays an inactivity alert which may be sent to a client computer device associated with a user account of a reviewer, in accordance with an embodiment.

FIG. 5 shows an illustrative graphical user interface that displays an inactivity alert which may be sent to a client computer device associated with a user account of a learner, in accordance with an embodiment.

FIG. 6 shows an illustrative graphical user interface that displays an inactivity alert which may be sent to client computer device associated with a user account of a coach, in accordance with an embodiment.

FIG. 7 is a diagram of an illustrative process flow that may be performed to generate and send one or more customized observation alerts in response to determining that an observation note has been submitted for a goal of a learner, in accordance with an embodiment.

FIG. 8 shows an illustrative graphical user interface that displays an observation alert which may be sent to a client computer device associated with a user account of a learner, in accordance with an embodiment.

FIG. 9 shows an illustrative graphical user interface that displays an observation alert which may be sent to a client computer device associated with a user account of a coach, in accordance with an embodiment.

FIG. 10 shows a diagram of an illustrative process flow that may be performed to generate and send one or more customized delta alerts in response to identifying a large rating differential between a goal rating submitted by a learner and a goal rating submitted by a rater, in accordance with an embodiment.

FIG. 11 shows an illustrative graphical user interface that displays a delta alert which may be sent to a client computer device associated with a user account of a learner, in accordance with an embodiment.

FIG. 12 shows an illustrative graphical user interface that displays a delta alert which may be sent to a client computer device associated with a user account of a coach, in accordance with an embodiment.

FIG. 13 is a diagram of an illustrative process flow that may be performed to generate and send one or more customized progress alerts in response to determining that goal ratings for a given goal of a learner have been sustained for a time period exceeding a predetermined progress threshold value, in accordance with an embodiment.

FIG. 14 shows an illustrative graphical user interface that displays a progress alert which may be sent to a client computer device associated with a user account of a learner, in accordance with an embodiment.

FIG. 15 shows an illustrative graphical user interface that displays a progress alert which may be sent to a client computer device associated with a user account of a coach, in accordance with an embodiment.

FIG. 16 shows an illustrative graphical user interface that displays a progress alert which may be sent to a client computer device associated with a user account of a reviewer, in accordance with an embodiment.

FIG. 17 is a diagram of an illustrative process flow that may be performed to periodically generate performance statistics for defined norm comparison groups for predefined categories and predefined time segments, in accordance with an embodiment.

FIG. 18 shows an illustrative graphical user interface that displays charts depicting running averages of goal ratings submitted by a learner and goal ratings submitted by raters for the learner across predefined time periods for each of the learner's goals, in accordance with an embodiment.

FIG. 19 shows an illustrative graphical user interface that displays charts depicting how an average of goal ratings submitted by raters for each of the learner's goals compares to a selected norm comparison group's performance for those goals for a selected time segment, in accordance with an embodiment.

FIG. 20 is a flow chart depicting a process flow for performing a method for generating identifications of groups of users of the present system that may be connected to one another enabling the formation of a learning pod having target or desired attributes.

FIG. 21 depicts an environment in which a user or learner of the present system may desire local and real-time feedback from a number of reviewers of the present system.

FIG. 22 is a block diagram illustrating example functional components of a device configured in accordance with the present disclosure.

FIG. 23A is a flow chart depicting a method that a user of a device may use to request feedback from nearby reviewers.

FIG. 23B is a flow chart depicting a method that a recipient device that is within range of the transmitting device of the method of FIG. 23A may utilize to enable a user or reviewer to provide feedback.

FIGS. 24A-24F depict an illustrative graphical user interface of various functionality implemented within the present system.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Systems and methods described herein relate generally to providing a user with real-time, continuous quantitative and qualitative data regarding the user's performance and learning for specific goals set by the user. Multiple users may interact with the system, with each user being associated with settings and permissions tied to their user account. Each user account may be assigned a particular class, corresponding to one of a number of roles, which determines the responsibilities and permissions of the user account. The class of a given user account may determine which alerts are received by the user account. Classes may include: learner, coach, reviewer, and rater.

The overall role of the learner may be to leverage the systems and methods described herein to accelerate their learning. For example, the learner can be thought of as a key athlete or quarterback whose sole purpose is to enhance his or her skills, including better execution of plays for the benefit of the team (or business). The learner may receive customized alerts related to the learner's performance, which may provide the learner with real-time performance feedback. Given the nature of receiving real-time feedback, the learner can therefore very quickly course correct as one might see in a sports arena when reviewing “game film.” After establishing goals and inviting raters via the system, the learner may leverage various features to understand the impact the learner is having on a particular goal. The learner can provide self-evaluation ratings via a graphical user interface generated and displayed on a client computer device of the learner, as well as review all qualitative, quantitative data provided by his/her raters. Customized alerts received by the learner may drive engagement into the learner's goal and provide insights to the learner that may lead to positive changes in the learner's behavior.

The overall role of the reviewer is to ensure the learning environment is set up as best as possible for the learner. Continuing with the above example, the reviewer may be considered as an assistant coach. Their responsibilities include providing feedback to the learner regarding development goal(s), rater selection and profile data. The reviewer may have permission to view the learner's goal benefit statement, key actions, and all profile data (including strengths). The reviewer cannot make any changes anywhere on the learner's user account. The reviewer may receive select alerts—for example if a rater has been inactive it may be useful for the reviewer to know this so that the reviewer may check in with the idle rater. Receiving these alerts may allow the reviewer to keep the learning environment active for the learner.

The role of rater is to provide real-time feedback to help a learner understand how effective the learner is with a given action in relation to the learner's specific goal. Continuing with the above example, the rater may be considered as a senior analyst sitting in the booth above the field. The rater not only needs to provide feedback but also “break down” a play (e.g., action) to help the learner understand what behaviors and actions the learner should continue to exhibit and what behaviors and actions could be improved or should be ceased. The rater may provide feedback to a learner on a specified goal via a graphical user interface generated and displayed on a client computer device of the rater. The rater may provide both quantitative and qualitative data to the learner. The rater can provide a numeric rating as well as a qualitative behavioral observation note. If the rater provides a rating that breaches a specific threshold (high or low) then the rater may be prompted to leave an observation note for the learner. The rater may receive periodic reminders to provide a rating, as well as alerts if the rater has been inactive.

The role of the coach is to help the learner to grow and perform. Continuing with the above example, the coach may be considered a “special teams” coach focused on helping the “athlete” (learner) gain skills. The coach can be an internal or external coach assigned to a learner. The coach can generally access all of the same information that the learner can in a “read only” fashion. The coach may receive the same alerts the learner receives, but in some embodiments the learner may optionally disable the coach's ability to receive these alerts.

Interactions between the system and learners, raters, coaches, and reviewers (e.g., the generation, sending, and receiving of customized alerts) may rely on electronic communications between back-end server devices and client devices of these users over one or more communications networks.

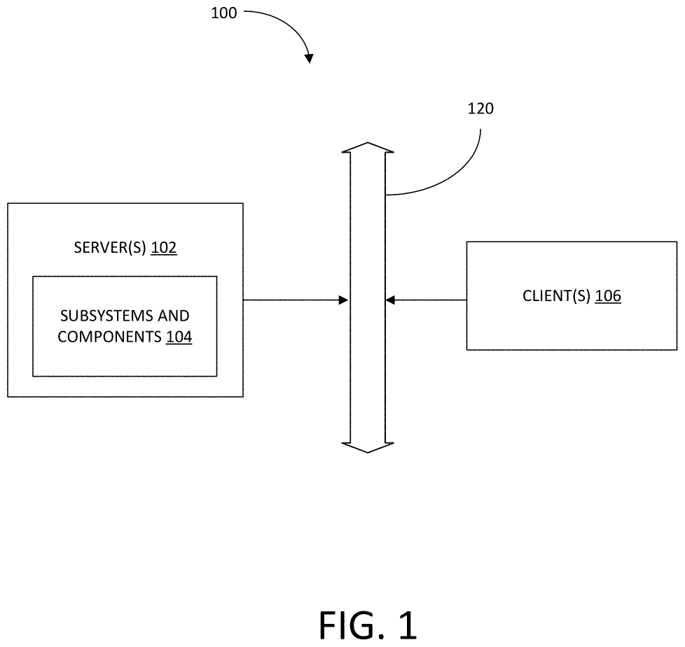

FIG. 1 illustrates a non-limiting example distributed computing environment 100, which includes one or more server computing devices 102 (sometimes referred to as computer servers, server devices, or servers), one or more client computing devices 106, and other components that may implement certain embodiments and features described herein. The server 102, client 106, or any other devices may be configured to implement a client-server model or any other distributed computing architecture.

Server 102, client(s) 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

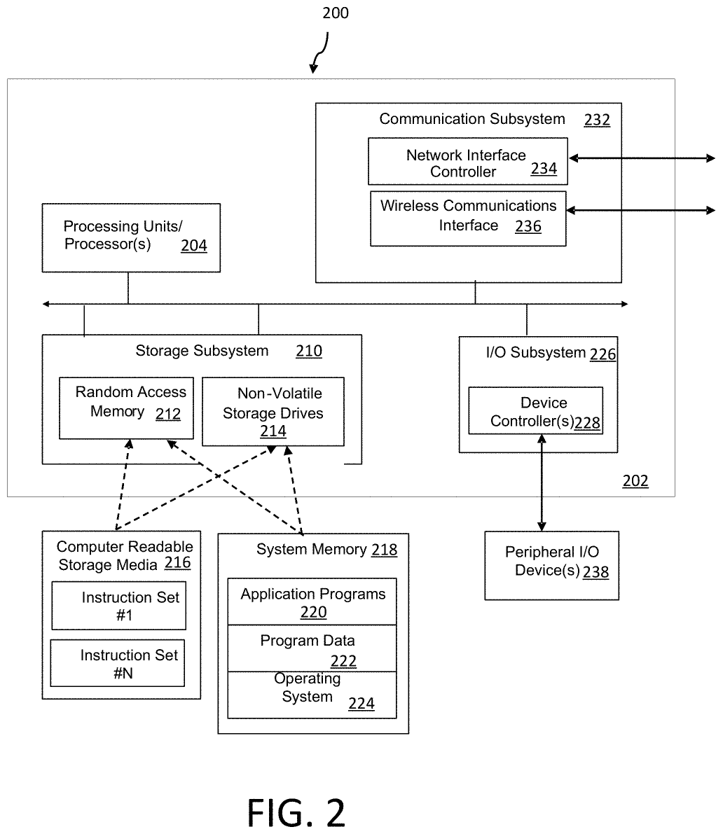

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser-based applications and/or standalone software applications, such as mobile device applications. Client devices 106 may receive client applications from server 102 or from other application providers (e.g., public or private application stores).

With reference now to FIG. 2, a block diagram of an illustrative computer system is shown. The system 200 may correspond to any of the client devices 106 or servers 102 of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code and may maintain multiple concurrently executing programs or processes. Processor(s) 204 may also include one or more specialized processors, (e.g., digital signal processors (DSPs), outboard, graphics application-specific, and/or other processors).

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210.

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.11 family standards, or other mobile communication technologies, or any combination thereof), global positioning system (GPS) receiver components, and/or other components.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

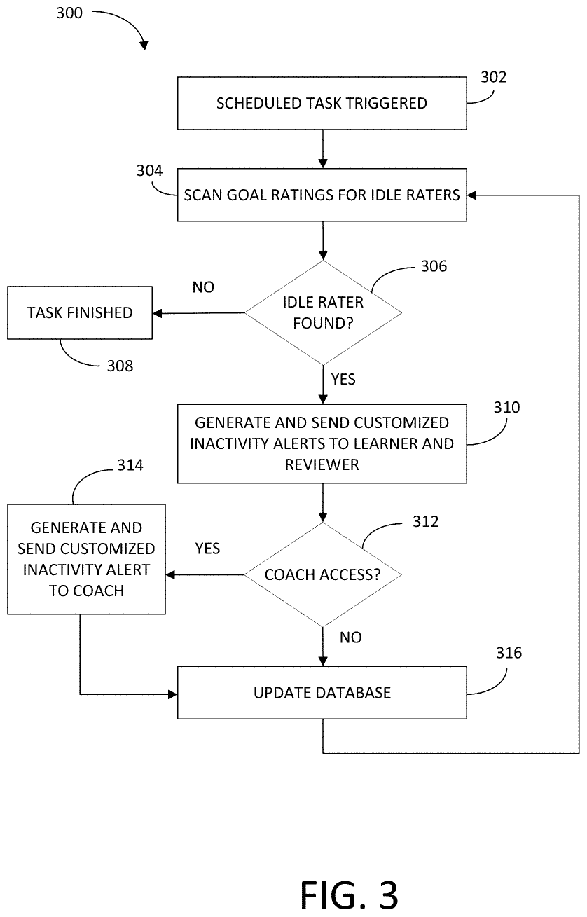

Returning to FIG. 1, in embodiments of the present invention, the server(s) 102, client(s) 106, and communication network 120 of distributed computing system 100 may enable the execution of improved methods for providing real-time, personalized feedback, evaluation, and goal management for professional development of a learner, which may accelerate and shorten the learning cycle. For example, one or more processors 204 in any of the servers 102 and clients 106 of distributed computing system 100 may execute instructions stored in computer readable storage media 216 corresponding to the generation, transmission, and receipt of customized alerts pertaining to various aspects of feedback provided for a learner by a rater, or by the learner themselves. These customized alerts may include, but are not limited to, inactivity alerts, observation alerts, delta alerts, and progress alerts. Details corresponding to these alerts will be described in detail in connection with the methods illustrated in FIGS. 3, 7, 10, and 13, below.

Turning now to FIG. 3, a process flow for performing a method 300 for generating and sending one or more customized inactivity alerts in response to identified rater inactivity is shown. Method 300 may, for example, be performed by executing, on a computer processor included in a server computer system (e.g., servers 102 shown in FIG. 1) instructions stored on a non-transitory computer readable storage medium.

As used herein, a “goal” may be defined as a particular skill or quality for which a learner desires improvement. Examples of goals that may be set by a learner may include agility, public speaking, client service, leadership, and efficiency, among others.

As used herein, a “goal rating” may be defined as a numerical value provided by a rater or by a learner as an evaluation of the learner's performance (e.g., via a graphical user interface displayed on a client computer device of the present system). For example, goal ratings may be submitted for a learner's goal of “Agility” by a rater or by the learner as numerical values between 0 and 10, corresponding to an evaluation of the learner's proficiency in the goal from lowest proficiency to highest proficiency. This scale is merely illustrative and, if desired, any other applicable numeric scale may be used to define the range of possible goal ratings that may be submitted for the learner's goal.

As used herein, an “inactivity alert” refers to an alert that is sent from the server to one or more client computer devices (e.g., clients 106, FIG. 1) in response to the server's identification of a rater that has been idle for a time period exceeding a predefined inactivity threshold value.

As used herein, an “idle” rater may be defined as having failed to provide a numerical goal rating for a given goal of a learner. For example, a rater may be considered idle with respect to a learner's goal of “Agility” if the rater has not provided a goal rating for the learner's goal of “Agility” for more than a predefined inactivity threshold value of two weeks.

In some embodiments, this predefined inactivity threshold value may be defined in the memory of the server (e.g., set by a system administrator) and may not be changed by the learner. In other embodiments, the predefined inactivity threshold value may be predefined by the learner (e.g., set by the learner through a user interface accessible by the learner) for an individual goal or for all goals simultaneously. In some embodiments, the learner may enable or disable inactivity alerts by altering their user account settings.

At step 302, a scheduled task is triggered, initializing the execution of method 300. For example, the server may be configured to execute method 300 to check for rater inactivity once per day at a specified time. In some embodiments, the frequency with which the task of performing method 300 is scheduled to occur may be set by the learner.

At step 304, the server scans each goal rating stored in the server's storage media (e.g., where each goal rating is stored upon being electronically submitted by a rater for a learner) in order to identify any raters that are considered to be idle. As indicated above, idle raters are raters that have not submitted a goal rating for a time period exceeding a predefined inactivity threshold set by the learner or set by a system administrator).

At step 306, the server determines whether an idle rater was identified during step 304. If no idle rater was identified, method 300 proceeds to step 308 to complete the scheduled task. Otherwise, if an idle rater was identified, method 300 proceeds to step 310.

At step 310, the server generates and sends customized inactivity alerts to client computer devices associated with respective user accounts of the learner and a reviewer corresponding to the learner. For example, the customized inactivity alerts may be sent to client computer devices of the learner and the reviewer as short message service (SMS) messages, e-mail messages, and/or push notifications provided through an application running on the client computer devices.

At step 312, the server determines whether a coach corresponding to the learner has been given access to receive the same inactivity alerts as the learner. For example, the learner may give the coach access to the learner's inactivity alerts by updating a corresponding setting in the learner's user account. If the coach has been given access to the learner's inactivity alerts, method 300 proceeds to step 314. Otherwise, if the coach has not been given access to the learner's inactivity alerts method 300 proceeds to step 316.

At step 314, the server generates and sends a customized inactivity alert to a client computer device associated with a user account of the coach. For example, the customized inactivity alert may be sent to a client computer device of the coach as short message service (SMS) messages, e-mail messages, and/or push notifications provided through an application running on the client computer device.

At step 316, the server may update a database that is stored in a storage medium (e.g., storage media 216, FIG. 2) to record that inactivity alerts have been generated and sent regarding the idle rater in the context of the particular goal of the learner for which the rater in question has been idle. In this way, the server may omit idle raters for which inactivity alerts have already been sent from subsequent results of the scan performed at step 304. After the database has been updated, method 300 returns to step 304 to scan goal ratings for any additional idle raters, thereby creating an iterative loop within method 300.

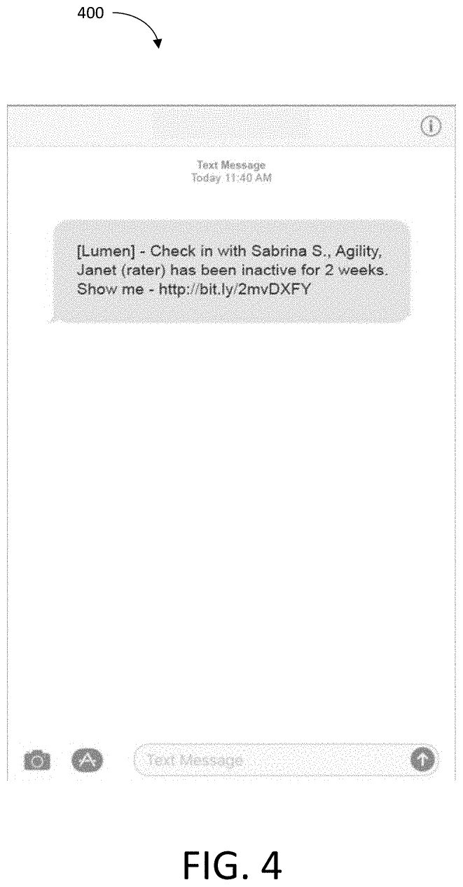

An illustrative inactivity alert 400 that may be generated at step 310 of FIG. 3 and subsequently displayed on a client computing device of a reviewer is shown in FIG. 4. While SMS text messages are shown in the examples of FIGS. 4, 5, 6, 8, 9, 11, 12, 14, and 15, it should be noted that other electronic communication techniques may be used to generate, send, and display the inactivity alert. Inactivity alert 400 may inform the reviewer that the idle rater, Janet, has been inactive for 2 weeks in connection with providing ratings for the goal, “Agility,” of the learner, Sabrina S.

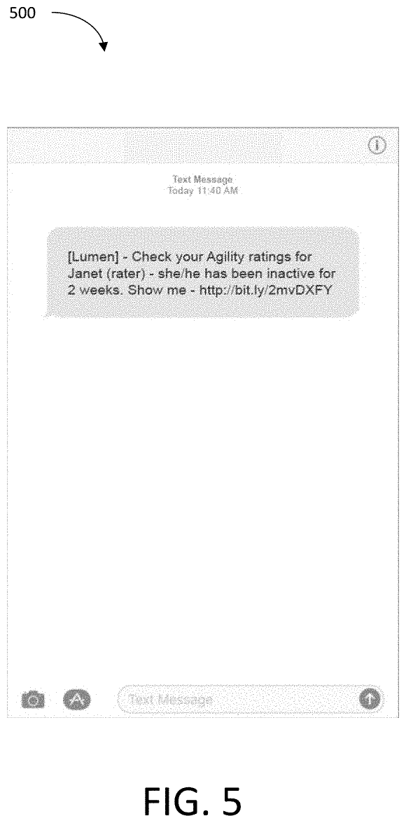

An illustrative inactivity alert 500 that may be generated at step 310 of FIG. 3 and subsequently displayed on a client computing device of a learner is shown in FIG. 5. Inactivity alert 500 may inform the learner that the idle rater has been inactive for 2 weeks in connection with providing ratings for the goal of “Agility” of the learner. An automatically generated URL may also be provided in inactivity alert 500, which, when selected (e.g., clicked or tapped), may open a screen showing the ratings that have been submitted for the learner's goal of “Agility”. This screen may, for example, be presented through a software application of the present system that is running on the learner's client computing device.

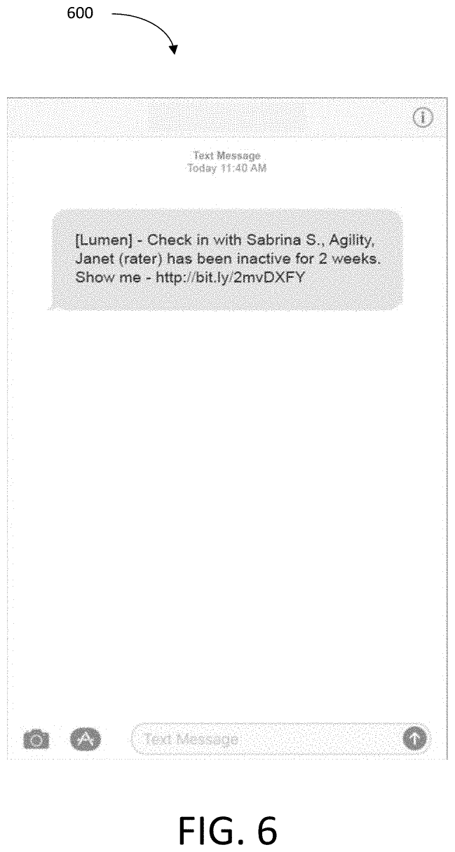

An illustrative inactivity alert 600 that may be generated at step 314 of FIG. 3 and subsequently displayed on a client computing device of a coach is shown in FIG. 6. Inactivity alert 600 may inform the coach that the idle rater, Janet, has been inactive for 2 weeks in connection with providing ratings for the goal, “Agility,” of the learner, Sabrina S. An automatically generated URL may also be provided in inactivity alert 600, which, when selected (e.g., clicked or tapped), may open a screen showing the ratings that have been submitted for the learner's goal of “Agility.” This screen may, for example, be presented through a software application of the present system that is running on the coach's client computing device.

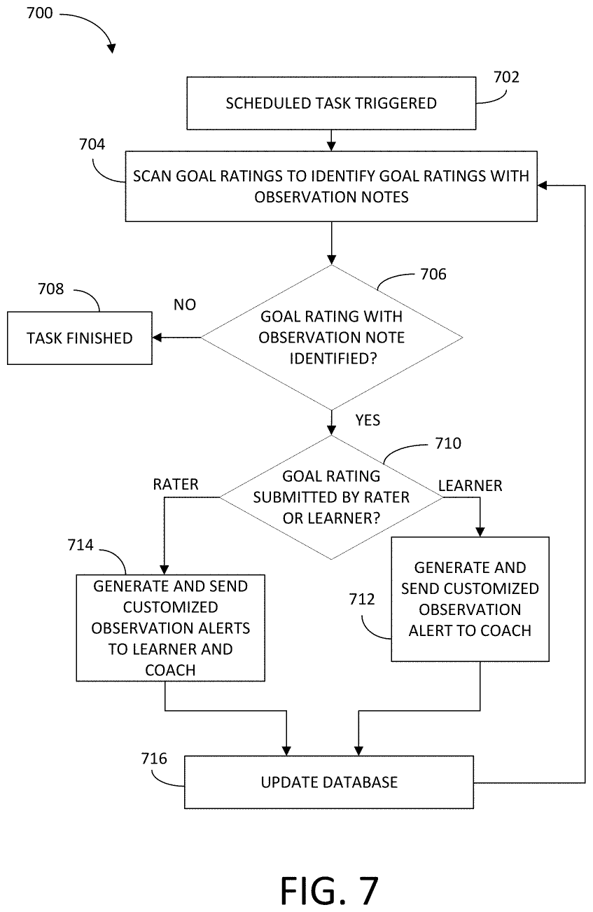

Turning now to FIG. 7, a process flow for performing a method 700 for generating and sending one or more customized observation alerts in response to determining that an observation note has been submitted with a goal rating is shown. Method 700 may, for example, be performed by executing, on a computer processor included in a server computer system (e.g., servers 102 shown in FIG. 1) instructions stored on a non-transitory computer readable storage medium.

As used herein, an “observation alert” refers to an alert that is sent from the server to one or more client computer devices (e.g., clients 106, FIG. 1) in response to the server's determination that an observation note has been submitted along with a corresponding goal rating. For example, a rater may provide feedback to a learner on a specified goal in the form of a numeric rating and, optionally, an observation note that provides qualitative feedback to the learner.

In some embodiments, the rater may be prompted to leave an observation note if the rater provides a numeric rating that breaches one of two predefined high and low rating threshold values (e.g., if the numeric rating is less than 4 or greater than 8 on a 10-point scale). The learner may be sent an observation alert (e.g., via SMS message or a push notification) in response to an observation note being left by a rater. In some embodiments, the learner may enable or disable observation alerts by altering their user account settings. By alerting the learner that a rater has left an observation note in real-time, the learner is given the opportunity to immediately respond to the feedback. The observation alert may enable the learner to quickly take corrective action if the observation note contains negative feedback and/or suggestions for improvement, or reinforces the learner's behavior if the observation note contains positive feedback. Additionally, the observation alert may encourage the learner to engage with the rater directly to discuss negative feedback while the cause of the negative feedback is still fresh in the rater's memory. A learner may also leave an observation note when submitting a goal rating for themselves. For example, it may be beneficial for a learner to leave an observation note for self so that, when reviewing their own progress in the future, qualitative context is available to remind the learner of the circumstances surrounding the goal rating corresponding to the observation note the learner left for self. In some embodiments, a coach of the learner may also receive an observation alert in response to an observation note being left by a rater. Receiving an observation alert may prompt the coach to contact or meet with the learner to review the observation note and/or the learner's progress toward the corresponding goal.

At step 702, a scheduled task is triggered, initializing the execution of method 700. For example, the server may be configured to execute method 700 to check for observation alerts once every 48 hours at a specified time. It should be understood that the 48 hour time period for executing method 700 provided here is intended to be illustrative and not limiting, and that, if desired, method 700 may be scheduled for execution at other time periods (e.g., 24 hours, 12 hours, etc.). In some embodiments, the frequency with which the task of performing method 700 is scheduled to occur may be set by the learner.

At step 704, the server scans each goal rating stored in the server's storage media (e.g., where each goal rating is stored upon being electronically submitted by a learner or by a rater for the learner) in order to identify whether any goal ratings with observation notes have been submitted. In some embodiments, additional predefined conditions may be required in order for an observation alert to be generated for a given goal rating. For example, these predefined conditions may include observation alerts being enabled for the learner's goal corresponding to the given goal rating.

At step 706, the server determines whether a goal rating with an observation note was identified in step 704. If no such goal rating was identified, method 700 proceeds to step 708 to complete the scheduled task. Otherwise, if a goal rating with an observation note was identified, method 700 proceeds to step 710.

At step 710, the server determines whether the identified goal rating was submitted by a rater or by the learner. If the identified goal rating was submitted by a learner, then method 700 proceeds to step 712. Otherwise, if the identified goal rating was submitted by a rater, then method 700 proceeds to step 714.

At step 712, the server generates and sends a customized observation alert to a client computer device associated with a user account of a coach corresponding to the learner. For example, the customized observation alert may be sent to a client computer device of the coach as short message service (SMS) messages, e-mail messages, and/or push notifications provided through an application running on the client computer device.

At step 714, the server generates and sends customized observation alerts to client computer devices associated with respective user accounts of the learner and the coach. For example, the customized observation alerts may be sent to client computer devices of the learner and the coach as short message service (SMS) messages, e-mail messages, and/or push notifications provided through an application running on the client computer devices.

At step 716, the server may update a database that is stored in a storage medium (e.g., storage media 216, FIG. 2) to record that observation alerts have been generated and sent regarding the identified goal rating. In this way, the server may omit the identified goal rating from subsequent results of the scan of goal ratings performed at step 704. After the database has been updated, method 700 returns to step 704 to scan goal ratings for any additional goal ratings having corresponding observation notes, thereby creating an iterative loop within method 700.

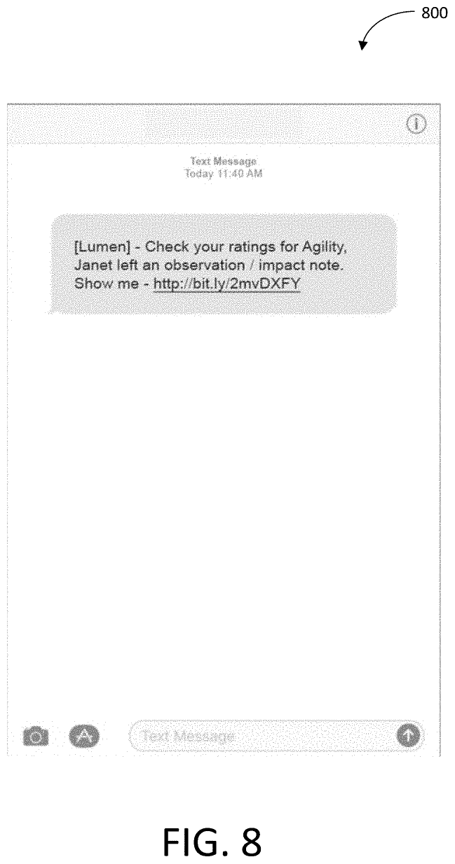

An illustrative observation alert 800 that may be generated at step 714 of FIG. 7 and subsequently displayed on a client computing device of a learner is shown in FIG. 8. Observation alert 800 may inform the learner that a rater, Janet, has left an observation note under the learner's ratings for the goal of “Agility.” An automatically generated URL may also be provided in observation alert 800, which, when selected (e.g., clicked or tapped), may open a screen showing the ratings that have been submitted for the learner's goal of “Agility.” This screen may, for example, be presented through a software application of the present system that is running on the learner's client computing device.

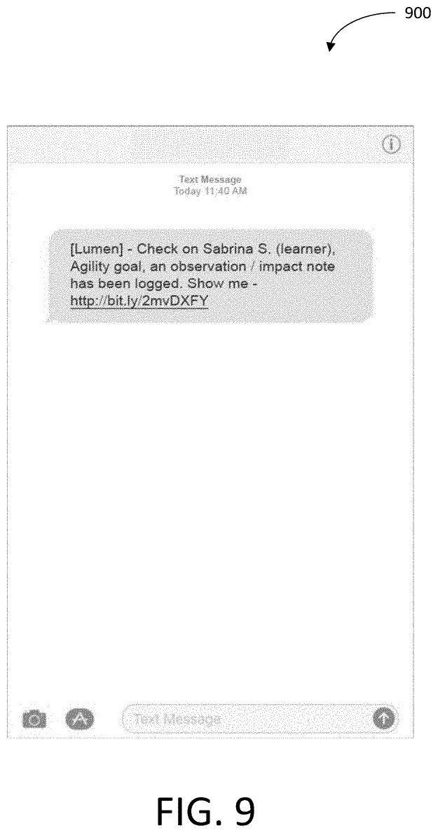

An illustrative observation alert 900 that may be generated at step 712 or step 714 of FIG. 7 and subsequently displayed on a client computing device of a coach is shown in FIG. 9. Observation alert 900 may inform the coach that an observation note has been submitted for the goal, “Agility,” of the learner, Sabrina S. An automatically generated URL may also be provided in observation alert 900, which, when selected (e.g., clicked or tapped), may open a screen showing the ratings that have been submitted for the learner's goal of “Agility.” This screen may, for example, be presented through a software application of the present system that is running on the coach's client computing device.

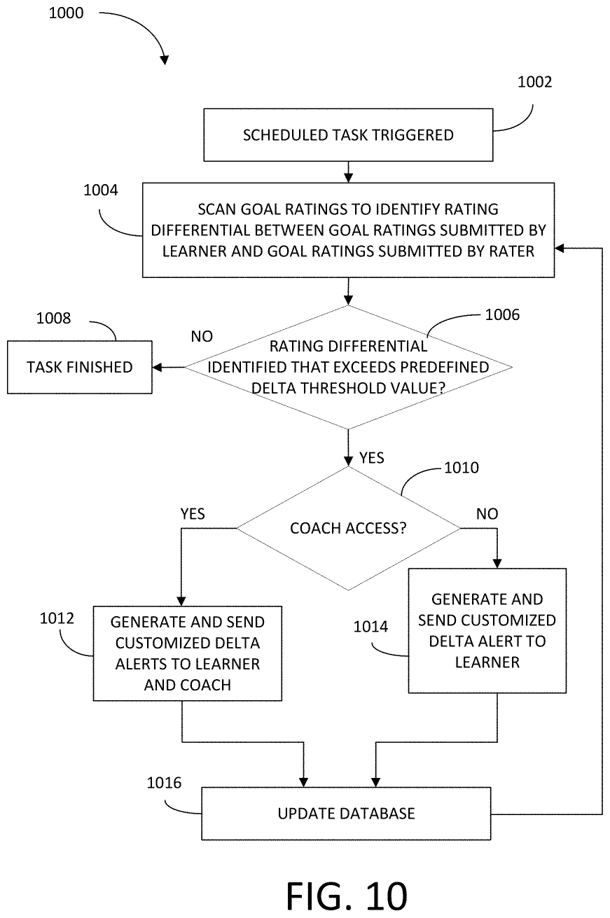

Turning now to FIG. 10, a process flow for performing a method 1000 for generating and sending one or more customized delta alerts in response to identifying a rating differential between a most recent goal rating submitted by a learner and any goal rating submitted by a rater within a predetermined period, is shown. Method 1000 may, for example, be performed by executing, on a computer processor included in a server computer system (e.g., servers 102 shown in FIG. 1) instructions stored on a non-transitory computer readable storage medium.

As used herein, a “delta alert” refers to an alert that is sent from the server to one or more client computer devices (e.g., clients 106, FIG. 1) in response to the server's determination that a rating differential exists between goal ratings submitted by a learner and goal ratings submitted by a rater for a given goal of the learner over a predetermined time period, and that this rating differential exceeds a predefined delta threshold value. For example, the server may determine the values of goal ratings submitted by the learner for a given goal of the learner (e.g., the goal of “Agility”). The server may then analyze all goal ratings submitted by raters for the given goal of the learner over a 7-day period to identify any rating differential that exists between the goal ratings submitted by the rater and the goal ratings submitted by the learner during that period that exceeds the predefined delta threshold (e.g., 3). For a given goal of the learner, the server may first determine one or more rating differentials. For example, the server may determine a rating differential by calculating the difference between the highest (i.e., maximum) goal rating of the set of goal ratings submitted by the learner for the given goal and the lowest (i.e., minimum) goal rating of the set of goal ratings submitted by the rater for the given goal over the predetermined time period (referred to herein as a “max-to-min rating differential”). As another example, the server may determine a rating differential by calculating the difference between the lowest (i.e., minimum) goal rating of the set of goal ratings submitted by the learner for the given goal and the highest (i.e., maximum) goal rating of the set of goal ratings submitted by the rater for the given goal over the predetermined time period (referred to herein as a “min-to-max rating differential”). In some embodiments, the server may calculate both the min-to-max rating differential and the max-to-min rating differential for comparison to the predetermined delta threshold value. The server may then compare each of the one or more rating differentials to a predefined delta threshold value. If the server determines that any of the one or more rating differentials exceeds the predefined delta threshold value, the server may generate and send customized delta alerts to client computer devices associated with respective user accounts of the learner and/or a coach corresponding to the learner. In this way, the learner may be quickly informed of any large discrepancies that may exist between the learner's self-evaluation for a goal and the evaluation of a given rater for that goal. It should be understood that the 7-day period over which goal ratings submitted by raters are analyzed is intended to be illustrative and not limiting. If desired, other time periods across which to analyze goal ratings submitted by raters may be used (e.g., 14 days, 3 days, etc.). In some embodiments, the predefined delta threshold value and/or the time period over which the rating differential is assessed may be set by the learner.

At step 1002, a scheduled task is triggered, initializing the execution of method 1000. For example, the server may be configured to execute method 1000 to check for a rating differential exceeding the predefined delta threshold value once every 7 days at a specified time. In some embodiments, the frequency with which the task of performing method 1000 is scheduled to occur may be set by the learner. In some embodiments, the server may be scheduled to execute method 1000 at different times and at different frequencies for various different goals of the learner, as defined by the learner. In some embodiments, the learner may enable or disable delta alerts by altering their user account settings.

At step 1004, the server scans each goal rating that corresponds to a given goal of the learner. These goal ratings may be stored in the server's storage media (e.g., where each goal rating is stored upon being electronically submitted by a learner or by a rater for the learner). The server then calculates one or more rating differentials between the goal ratings submitted by the learner and goal ratings submitted by the rater over a predetermined time period. For example, the server may identify the most recent goal rating submitted by the learner and may identify all goal ratings submitted by raters for the given goal over a 7-day time period. Then, for each rater, the server may calculate one or more rating differentials between the goal ratings submitted by that rater and the most recent goal rating submitted by the learner over the 7-day time period. A rating differential may be calculated as the difference between a given goal rating submitted by a rater and the most recent goal rating submitted by the learner. As another example, the one or more rating differentials may include a min-to-max rating differential and/or a max-to-min rating differential, as described previously. The server may then determine whether any of the one or more rating differentials exceeds a predefined delta threshold value. The predefined delta threshold value may, for example, be set by the learner, or may be automatically set to a default value. In some embodiments, this default value may be 3.

The server may continue to calculate rating differentials for all raters that submitted goal ratings for the various goals of the learner over the 7-day time period until either the server identifies a rating differential that exceeds the predefined delta threshold value, or until the server has calculated all possible rating differentials for the various goals of the learner without identifying a rating differential that exceeds the predefined delta threshold value. In some embodiments, different predefined delta threshold values may be set by the learner for different goals of the learner. In this way, the learner may customize the predefined delta threshold values based upon their learning needs and learning style. In some embodiments, the learner may disable delta alerts for a subset of the learner's goals and method 1000 may omit goal ratings submitted by raters during the 7-day period for goals within this subset at step 1004.

At step 1006, if the server has not identified a rating differential that exceeds the predefined delta threshold value, then method 1000 proceeds to step 1008 to complete the scheduled task. Otherwise, if the server has identified a rating differential that exceeds the predefined delta threshold value, method 1000 proceeds to step 1010.

At step 1010, the server determines whether a coach corresponding to the learner has been given access to receive the same delta alerts as the learner. For example, the learner may give the coach access to the learner's delta alerts by updating a corresponding setting in the learner's user account. If the coach has been given access to the learner's delta alerts, method 1000 proceeds to step 1012. Otherwise, if the coach has not been given access to the learner's delta alerts, then method 1000 proceeds to step 1014.

At step 1012, the server generates and sends customized delta alerts to client computer devices associated with respective user accounts of the learner and the coach. For example, the customized delta alerts may be sent to client computer devices of the learner and the coach as short message service (SMS) messages, e-mail messages, and/or push notifications provided through an application running on the client computer devices.

At step 1014, the server generates and sends a customized delta alert to a client computer device associated with a user account of the learner. For example, the customized delta alert may be sent to a client computer device of the learner as short message service (SMS) messages, e-mail messages, and/or push notifications provided through an application running on the client computer device.

At step 1016, the server may update a database that is stored in a storage medium (e.g., storage media 216, FIG. 2) to record that delta alerts have been generated and sent for a given goal of the learner. In this way, the server may omit the goal ratings corresponding to the given goal from subsequent results of the scan of goal ratings performed at step 1004. After the database has been updated, method 1000 returns to step 1004 to scan goal ratings for rating differentials corresponding to other goals of the learner, thereby creating an iterative loop within method 1000.

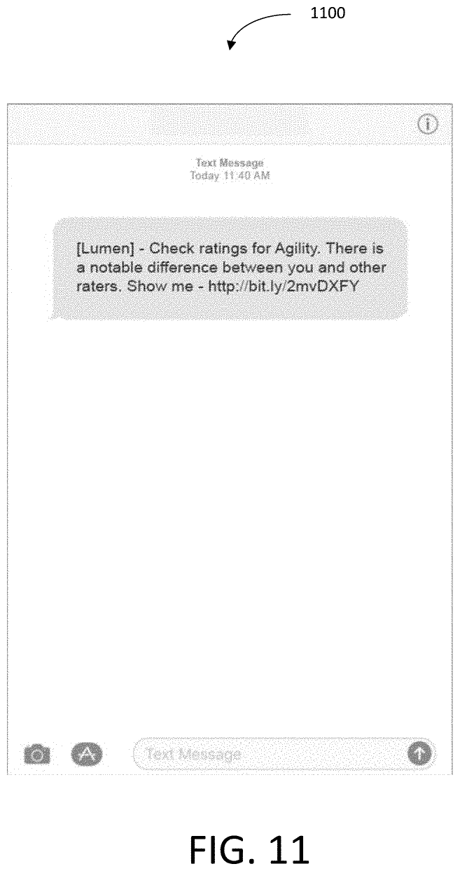

An illustrative delta alert 1100 that may be generated at step 1012 or step 1014 of FIG. 10 and subsequently displayed on a client computing device of a learner is shown in FIG. 11. Delta alert 1100 may inform the learner that there is a notable difference between a goal rating submitted by the learner and a goal rating submitted by a rater for the learner's goal of “Agility.” An automatically generated URL may also be provided in delta alert 1100, which, when selected (e.g., clicked or tapped), may open a screen showing the ratings that have been submitted for the learner's goal of “Agility.” This screen may, for example, be presented through a software application of the present system that is running on the learner's client computing device.

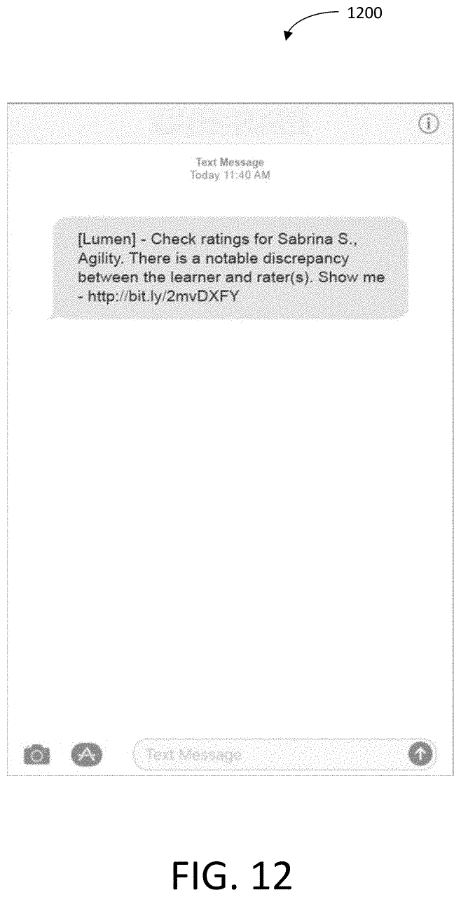

An illustrative delta alert 1200 that may be generated at step 1012 of FIG. 10 and subsequently displayed on a client computing device of a coach is shown in FIG. 12. Delta alert 1200 may inform the coach that there is a notable difference between a goal rating submitted by the learner and a goal rating submitted by a rater for the learner's goal of “Agility.” An automatically generated URL may also be provided in delta alert 1200, which, when selected (e.g., clicked or tapped), may open a screen showing the ratings that have been submitted for the learner's goal of “Agility.” This screen may, for example, be presented through a software application of the present system that is running on the coach's client computing device.

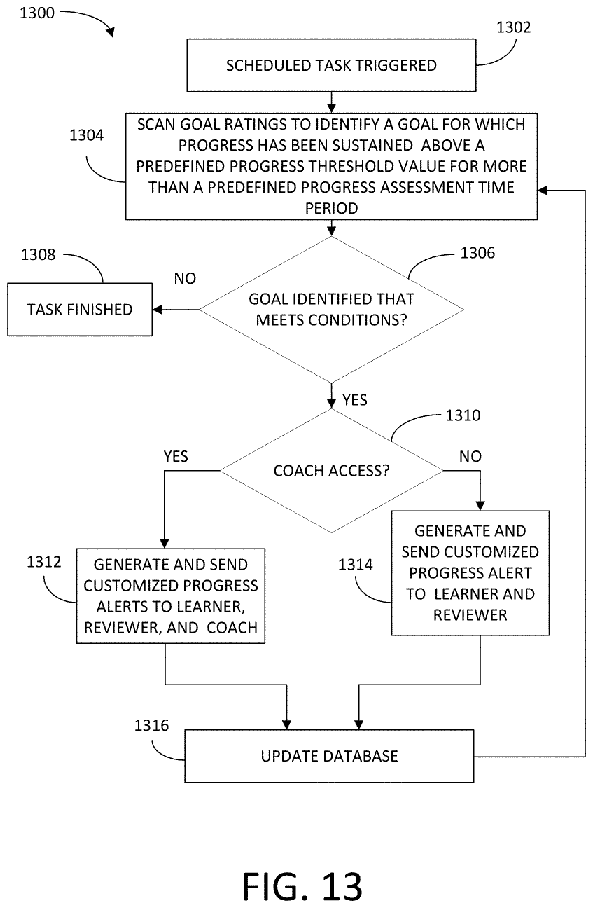

Turning now to FIG. 13, a process flow for performing a method 1300 for generating and sending one or more customized progress alerts in response to identifying a goal of a learner having a sustained amount of progress over a time period. Progress for a given goal may be defined based on the average value (e.g., mean value) of goal ratings submitted by raters for the given goal of the learner compared to a target goal rating value set by the learner. Method 1300 may, for example, be performed by executing, on a computer processor included in a server computer system (e.g., servers 102 shown in FIG. 1), instructions stored on a non-transitory computer readable medium.

As used herein, a “progress alert” refers to an alert that is sent from the server to one or more client computer devices (e.g., clients 106, FIG. 1) in response to the server's determination that a progress percentage for a goal of a learner has been maintained over a predefined progress threshold value for more than a predefined progress assessment time period. For example, the server may calculate the average value (e.g., mean value) of goal ratings submitted by raters for the learner's goal of “Agility” over a 7-day period. The learner may define a target goal rating value that the learner wants to achieve for the goal. The server may then determine the percentage of the target goal rating value that has been achieved by the learner by dividing the average value of the goal ratings for the goal by the target goal rating value. This percentage is referred to herein as a “progress percentage,” and may serve to quantify the amount of progress that has been made toward the target goal rating value for a given goal of the learner.

After determining the progress percentage, the server may compare the progress percentage to one or more predefined progress threshold values (e.g., 25%, 50%, 75%) to determine the maximum predefined progress threshold value exceeded by the progress percentage. If the average value of the goal ratings (as a percentage of the learner's target goal rating value) over the predefined progress assessment time period exceeds one or more of the predefined progress threshold values, the server may generate and send a customized progress alert to client computer devices associated with respective user accounts of the learner and reviewer and, optionally, the coach. In this way, positive reinforcement may be provided to the learner for the learner's progress toward the target goal rating value, keeping the learner motivated and engaged. Additionally, the reviewer and, optionally, the coach are kept informed regarding the learner's progress toward the target goal rating value and are thereby given the opportunity to provide proper reinforcement and recognition for the learner's efforts and progress. In some embodiments, the predefined progress threshold value(s) and/or the predefined progress assessment time period may be set by the learner. In some embodiments, the learner may enable or disable progress alerts by altering their user account settings.

At step 1302, a scheduled task is triggered, initializing the execution of method 1300. For example, the server may be configured to execute method 1300 to check for a rating differential exceeding the predefined delta threshold value once every 7 days at a specified time. In some embodiments, the frequency with which the task of performing method 1300 is scheduled to occur may be set by the learner. In some embodiments, the server may be scheduled to execute method 1300 at different times and at different frequencies for various different goals of the learner, as defined by the learner.

At step 1304, the server scans goal ratings in order to identify a goal for which progress has been sustained above a predefined progress threshold value for more than a predefined progress assessment time period. These goal ratings may be stored in the server's storage media (e.g., where each goal rating is stored upon being electronically submitted by a rater for the learner). For example, the server may calculate an average value (e.g., mean value) of all goal ratings submitted by raters for a given goal of the learner during a 7-day time period. In some embodiments, the predefined progress assessment time period may be set by the learner. The server may then determine a progress percentage (representing a percentage of the learner's target goal rating value that has been achieved) by dividing the calculated average value by a target goal rating value predefined by the learner and multiplying the result of this division by 100. The server may then compare the determined progress percentage to one or more predefined progress threshold values (e.g., 25%, 50%, 75%, 100%). In some embodiments, the predefined progress threshold values may be set by the learner. The given goal is identified by the server as having sustained progress over the predefined progress assessment time period if the determined progress percentage exceeds any of the predefined progress threshold values. If the determined progress percentage does not exceed any of the predefined progress threshold values, then the server may proceed to scan goal ratings corresponding to other goals of the learner until all goal ratings submitted by raters have been scanned.

At step 1306, if the server has not identified a goal for which progress has been sustained after scanning all goal ratings, then method 1300 proceeds to step 1308 to complete the scheduled task. Otherwise, if the server has identified a goal for which the progress percentage has been sustained above the predefined progress threshold value(s), method 1300 proceeds to step 1310.

At step 1310, the server determines whether a coach corresponding to the learner has been given access to receive the same progress alerts as the learner. For example, the learner may give the coach access to the learner's progress alerts by updating a corresponding setting in the learner's user account. If the coach has been given access to the learner's progress alerts, method 1300 proceeds to step 1312. Otherwise, if the coach has not been given access to the learner's progress alerts, then method 1300 proceeds to step 1314.

At step 1312, the server generates and sends customized progress alerts to client computer devices associated with a respective user accounts of the learner, a reviewer corresponding to the learner, and the coach. For example, the customized progress alerts may be sent to client computer devices of the learner and the coach as short message service (SMS) messages, e-mail messages, and/or push notifications provided through an application running on the client computer devices.

At step 1314, the server generates and sends customized progress alerts to client computer devices associated with respective user accounts of the learner and the reviewer. For example, the customized progress alert may be sent to client computer devices of the learner and the reviewer as short message service (SMS) messages, e-mail messages, and/or push notifications provided through an application running on the client computer device.

At step 1316, the server may update a database that is stored in a storage medium (e.g., storage media 216, FIG. 2) to record that progress alerts have been generated and sent for the identified goal of the learner. In this way, the server may omit the goal ratings corresponding to the identified goal from subsequent results of the scan of goal ratings performed at step 1304. After the database has been updated, method 1300 returns to step 1304 to scan goal ratings to identify any other goals for which progress has been sustained above the predefined progress threshold value, thereby creating an iterative loop within method 1300.

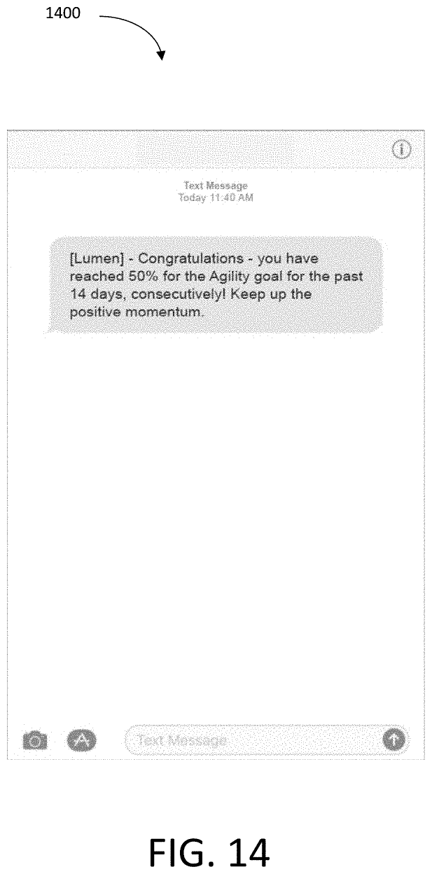

An illustrative progress alert 1400 that may be generated at step 1312 or step 1314 of FIG. 13 and subsequently displayed on a client computing device of a learner is shown in FIG. 14. Progress alert 1400 may inform the learner that the learner has exceeded the predefined progress threshold value (e.g., 50%) for a goal (e.g., agility) over a predefined progress assessment time period (e.g., 14 days).

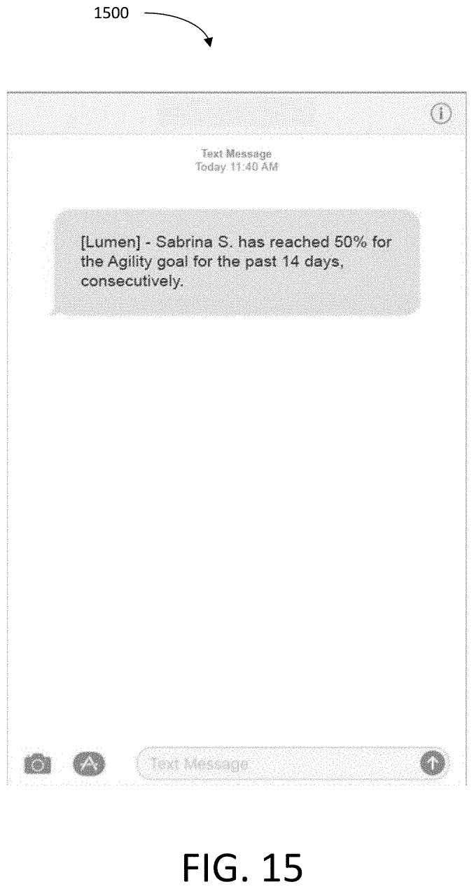

An illustrative progress alert 1500 that may be generated at step 1312 of FIG. 13 and subsequently displayed on a client computing device of a coach is shown in FIG. 15. Progress alert 1500 may inform the coach that the learner has exceeded the predefined progress threshold value (e.g., 50%) for a goal (e.g., agility) over a predefined progress assessment time period (e.g., 14 days).

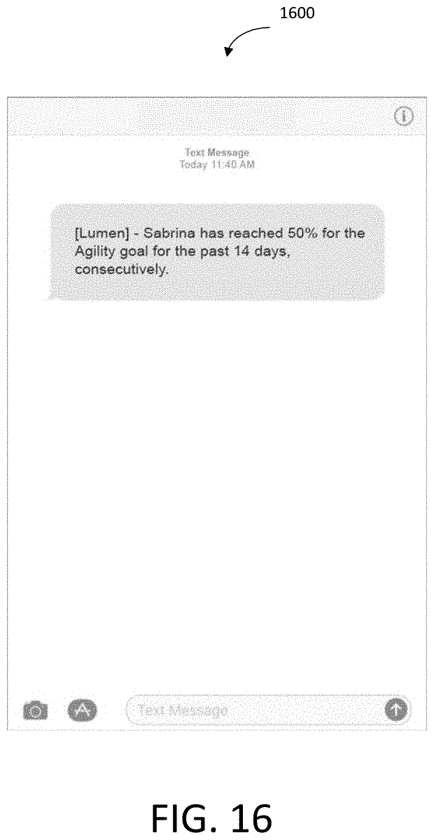

An illustrative progress alert 1600 that may be generated at step 1312 or step 1314 of FIG. 13 and subsequently displayed on a client computing device of a learner is shown in FIG. 16. Progress alert 1600 may inform the reviewer that the learner has exceeded the predefined progress threshold value (e.g., 50%) for a goal (e.g., agility) over a predefined progress assessment time period (e.g., 14 days).

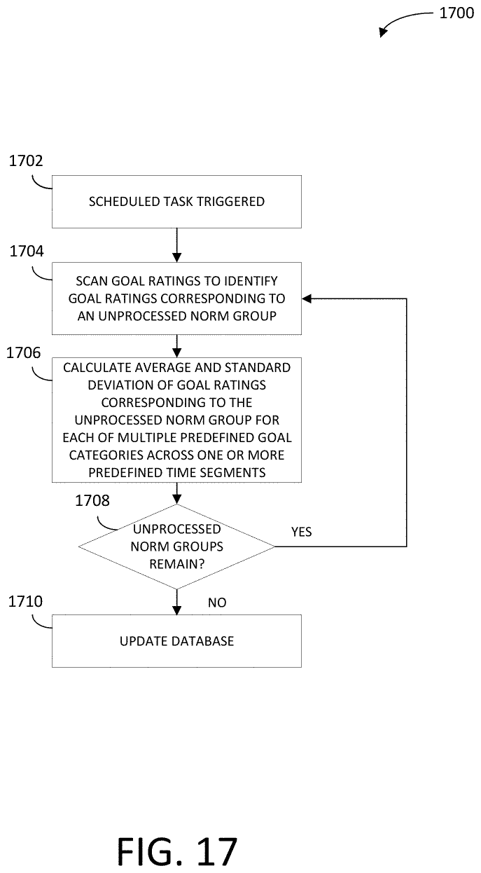

Turning now to FIG. 17, a process flow for performing a method 1300 for determining performance statistics for each of a number of defined norm groups. Method 1300 may, for example, be performed by executing, on a computer processor included in a server computer system (e.g., servers 102 shown in FIG. 1), instructions stored on a non-transitory computer readable medium.

Here, a “norm group” (sometimes referred to as a norm comparison group or a norm reference group) refers generally to a point of reference to which a learner's progress toward a given goal (e.g., quantified as an average or mean of all goal ratings submitted for the given goal of the learner by raters across a predefined time segment) may be compared. In some embodiments, a norm group may be a defined subset of all learners represented across all user accounts. The defining of a norm group may sometimes be referred to as “norm group generation.” For example, a norm group may include only learners belonging to a particular department, only learners located within a particular geographic region, only learners that belong to a particular department and that are located within a particular geographic region, or all learners within an organization. In some embodiments, a norm group may be a specified set of peer institutions. In some embodiments, a norm group may represent a set of industry standards.

In order to identify the subset of learners that correspond to particular norm groups, one or more norm group databases be maintained. The norm group databases may define “static” norm groups for different strata, including industries (e.g., financial, technology, defense, law, manufacturing, consulting, etc.), peer groups (e.g., with peers being defined based on factors such as market capitalization, revenue, number of employees, etc.), companies, departments (e.g., sales, human resources, research and development, etc.), and regions (e.g., North America, Mid-Western United States, greater Chicago area, etc.). The norm group databases may also allow cross tabulation of multiple strata.

When an industry-specific norm group is defined for a learner working in a given industry, all learners indicated in the norm group databases as working for companies in the given industry may be included in the industry-specific norm group. When a peer-specific norm group is defined for a learner working for a given company, all learners indicated in the norm group databases as working for companies within the defined peer group of the given company may be included in the peer-specific norm group. When a company-specific norm group is defined for a learner, all learners indicated in the norm group databases as working for that company may be included in the company-specific norm group. When a department-specific norm group is defined for a learner, all learners indicated in the norm group databases as working in the same department as the learner may be included in the department-specific norm group. When a region-specific norm group is defined for a learner, all learners indicated in the norm group databases as working in the same region as the learner may be included in the region-specific norm group. When a cross tabulation norm group that is both department-specific and region-specific is defined for a learner, all learners indicated in the norm group database as working in both the same region as the learner and the same department as the learner may be included in the cross tabulation norm group.

Additionally, a database of personalized information for individual learners may be maintained by the server, which may include, but is not limited to, the learner's educational level, years in industry, and career phase, for example. In some embodiments, a learner may cause norm groups to be defined dynamically by selecting one or more categories of personalized information of the learner from the database by which the otherwise “static” norm groups defined for the learner based on the norm group databases may be further customized. For example, a learner may define a user preference for “dynamic” norm group generation that causes the static norm groups defined for that learner to be customized according to education level, such that learners with a different education level than that of the learner are omitted when defining norm groups for the learner.

In some embodiments, the learner could select an option to cause “dynamic” norm group generation to be enabled or disabled (e.g., via a selectable option provided on a user interface such as the user interface 1900 of FIG. 9) according to a predetermined combination of categories of personalized information, rather than the user-defined combination of categories of personalized information described above. In some embodiments, an administrator for the system may define one or more predetermined combinations of categories of personalized information to be used for dynamic norm group generation. In some embodiments, instead of the learner, the administrator may set whether dynamic norm group generation is enabled or disabled for all learners or for individually selected learners.

Performance statistics fora norm group refer to averages (e.g., means) and standard deviations of goal ratings for that norm group corresponding to each of a number of predefined categories. For example, the predefined categories may include business/technical acumen, communication/engagement, building relationships/collaboration, mobilizing/influencing, critical thinking, planning and executing, developing talent, managing performance, and personal learning/leadership. For example, the performance statistics for a norm group consisting of all learners within a department may include an average (e.g., mean) and standard deviation for each of the nine predefined categories described in the above example, for a total of nine average-standard deviation pairs. When a learner creates a new goal, that goal may be assigned to one of the predefined categories, such that when the learner's progress toward the goal is compared to the norm group performance statistics, it is compared to the average-standard deviation pair of the norm group that corresponds to the assigned category. Performance statistics for defined norm groups may be stored in a database that is stored in a storage medium (e.g., storage media 216, FIG. 2). When a learner selects a norm group to compare their goal progress to, as will be described, the performance statistics may be retrieved from the database to generate corresponding charts, each showing an average of goal ratings submitted by raters for one of the learner's goals compared to the performance of the selected norm group for one of the predefined categories corresponding to that goal. The generated charts may be displayed via a graphical user interface shown on a screen of an electronic device of the learner, for example.

By providing points of reference for a learner to which they may compare their progress toward a given goal, a competitive element is created to motivate progress, learner accountability is deepened, and the learner is provided with insights to the company culture, standards, and expectations surrounding the learner.

At step 1702, a scheduled task is triggered, initializing the execution of method 1700. For example, the server may be configured to execute method 1700 periodically (e.g., once per day) in order to update performance statistics for defined norm groups and to update averages (e.g., means) of goal ratings submitted by raters for each individual learner. Performance statistics and goal rating averages for individual learners may be calculated for several different predefined time segments (e.g., based on corresponding goal ratings submitted during periods of 45 days, 60 days, and 90 days).

At step 1704, the server scans goal ratings in order to identify goal ratings (e.g., which may be limited to goal ratings submitted by raters) corresponding to an unprocessed norm group. The unprocessed norm group may be identified from a set of defined norm groups (e.g., “static” norm groups maintained by norm group databases, as defined previously). In some embodiments, only goal ratings submitted during one or more predefined time segments (e.g., 45 days, 60 days, and 90 days immediately preceding the date of the scan) may be identified by the server. Here, an “unprocessed” norm group refers to a norm group for which performance statistics have not yet been calculated during the present instance of method 1700.

At step 1706, the server calculates a separate average (e.g., mean) and standard deviation of identified goal ratings corresponding to the unprocessed norm group for each of multiple predefined goal categories across the one or more predefined time segments. For example, for an unprocessed defined norm group consisting of all learners within a department, the server may calculate the average and standard deviation of the identified goal ratings of the learners of the department corresponding to a Critical Thinking category for each of a 45-day, 60-day, and 90-day time segments. The server may then calculate the average and standard deviation for each other predefined category for each of the 45-day, 60-day, and 90-day time segments.

At step 1708, the server may determine whether any unprocessed norm groups remain of the set of defined norm groups. If so, the method 1700 returns to step 1704 and the server identifies goal ratings corresponding to another unprocessed norm group. Otherwise, the method 1700 proceeds to step 1710.

At step 1710, the server may update a database that is stored in a storage medium (e.g., storage media 216, FIG. 2) to record the performance statistics (e.g., the average-standard deviation pairs calculated for each predefined category) calculated for each norm group of the set of defined norm groups. Method 1700 may then end.

As will be described, subsequent to the performance of method 1700, the server may generate a chart (e.g., a color-coded chart) based on the mean and standard deviation of a defined norm group for a predefined category, the chart including an indicator representing the average goal rating of a learner. The chart may be divided into multiple sections, each section representing a range of goal ratings (e.g., a goal rating range) bounded by the mean and/or one or more standard deviations from the mean of the defined norm group for the predefined category. The generated chart may be displayed on a client computer device of the learner as part of a graphical user interface.

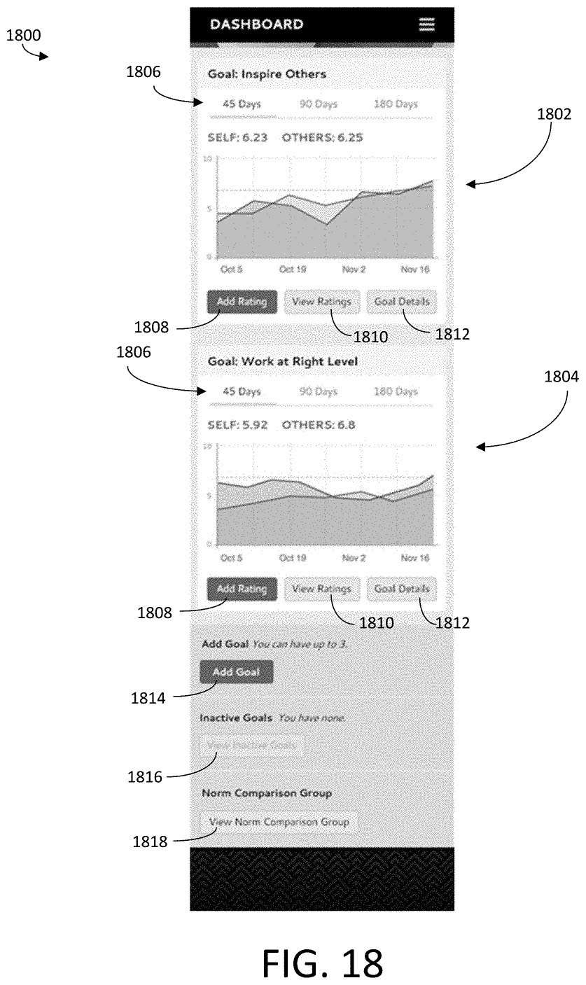

An illustrative graphical user interface (GUI) 1800 that may be accessed by a learner is shown in FIG. 18. GUI 1800 that shows charts 1802 and 1804, which the average of goal ratings submitted by the learner to the average of goal ratings submitted by raters over one or more predetermined time segments (e.g., 45 days) for each of the learner's goals (e.g., Inspire Others, and Work at Right Level). GUI 1800 may be displayed on a screen of an electronic device (e.g., client 106, FIG. 1) of the learner, for example, which may be in electronic communication via one or more electronic communication networks (e.g., communication network 120, FIG. 1) with one or more servers (e.g., servers 102, FIG. 1) that store one or more databases of goal ratings and other user data corresponding to the learner.

A number of selectable buttons may be provided as part of GUI 1800, which allow the learner to interact with GUI 1800 and to navigate to pages displaying different content. For example, buttons 1806 provide options for a 45-day, 90-day, or 180-day time segment to be selected as the period over which the goal rating averages shown in charts 1802 and 1804 are calculated. Buttons 1808, when selected by the learner, allow the learner to add a new rating for a corresponding goal of the learner. Buttons 1810, when selected by the learner, may cause ratings submitted for the corresponding goal of the learner to be displayed on the screen. Buttons 1812, when selected by the learner, cause goal details for the corresponding goal of the learner to be displayed on the screen. Button 1814, when selected by the learner, allows the learner to add a new goal. While the present example indicates an upper limit of 3 goals, it should be understood that this is intended to be illustrative and not limiting, and that a learner could be allowed to maintain more or fewer goals in other embodiments. Button 1816 allows the learner to view their inactive goals. For example, while a learner's goals may change over time, the learner may wish to look back at their performance on previous (i.e., inactive) goals for which their progress is no longer being tracked. In such embodiments, the server may maintain a database of data corresponding to the inactive goals of the learner. Button 1818, when selected by the learner, navigates to a norm comparison group page depicting one or more comparisons between the learner's goal performance (e.g., the average of goal ratings submitted by raters for a goal of the learner) for one or more goals of the learner compared to the performance of a selected norm comparison group.

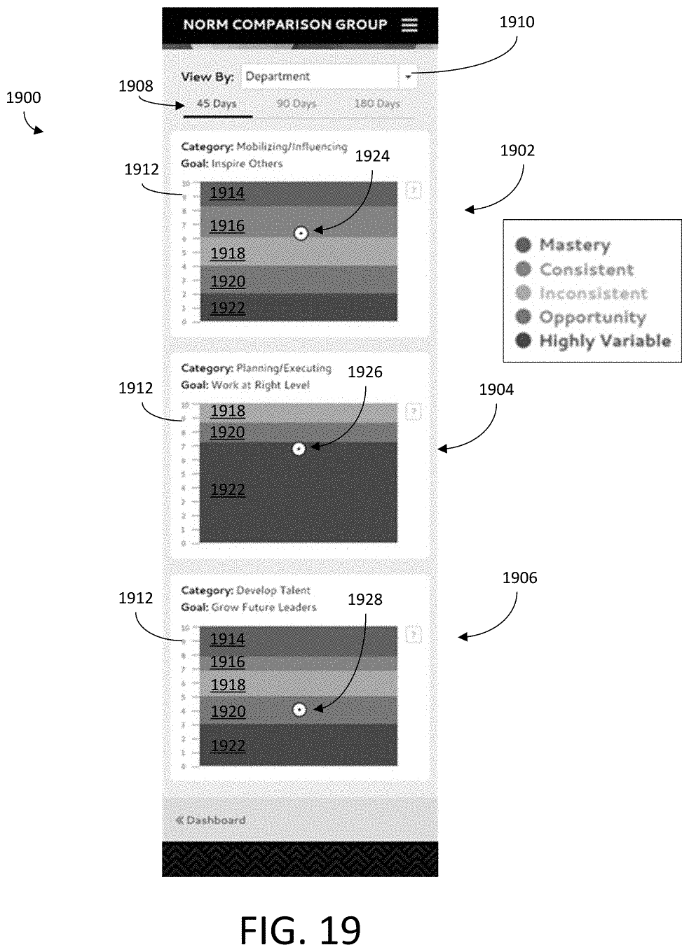

An example of such a norm comparison group page is shown in the illustrative GUI 1900 of FIG. 19. GUI 1900 that shows charts 1902, 1904, and 1906, depicting one or more comparisons between the learner's goal performance for one or more goals of the learner (e.g., Inspire Others, Work at Right Level, Grow Future Leaders) compared to the performance of a selected norm comparison group (e.g., all learners within the learner's department) in a corresponding category over a selected time segment (e.g., 45 days). GUI 1900 may be displayed on a screen of an electronic device (e.g., client 106, FIG. 1) of the learner, for example, which may be in electronic communication via one or more electronic communication networks (e.g., communication network 120, FIG. 1) with one or more servers (e.g., servers 102, FIG. 1) that store one or more databases of goal ratings and other user data corresponding to the learner.

Chart 1902 shows the average of goal ratings submitted by raters for the learner's goal of “Inspire Others,” represented by an indicator 1924, to the performance of a norm group that includes all learners in the learner's department for goals in the category of Mobilizing/Influencing over a 45-day time segment. The norm group used for comparison may be selected via a drop-down menu 1910. While the menu 1910 is shown here to be a drop-down menu, it should be understood that any other applicable menu type may be provided to enable the selection of the norm group used for comparison. For example, a list of all available norm groups may be provided in the menu 1910 and the learner may have the option of selecting a single norm group or of selecting multiple norm groups such that a cross tabulated norm group is defined that is limited to learners belonging to each of the selected norm groups. The time segment over which the performances of the learner and the norm group are considered may be selected via buttons 1908. While 45-day, 90-day, and 180-day options are shown to be selectable via buttons 1908, this is intended to be illustrative and not limiting, and other time segments may be available for selection via buttons 1908 in other embodiments.

As shown, the 1902 is color coded (as are charts 1904 and 1906). In the present example, the dark green section 1914 of the chart (e.g., corresponding to comparative mastery in goal performance) represents a range of goal ratings that are two or more standard deviations above the mean goal rating of the norm group in the corresponding category across the selected time segment. The light green section 1916 of the chart (e.g., corresponding to comparative consistency in goal performance) represents a range of goal ratings that are between one and two standard deviations above the mean goal ratings of the norm group in the corresponding category across the selected time segment. The yellow section 1918 of the chart (e.g., corresponding to comparative inconsistency in goal performance) represents a range of goal ratings that are between the mean goal rating and one standard deviation above the mean goal rating of the norm group in the corresponding category across the selected time segment. The orange section 1920 of the chart (e.g., corresponding to comparative opportunity for improvement in goal performance) represents a range of goal ratings that are between the mean goal rating and one standard deviation below the mean goal rating of the norm group in the corresponding category across the selected time segment. The red section 1922 of the chart (e.g., corresponding to comparatively highly variable goal performance) represents a range of goal ratings that are one standard deviation or more below the mean goal rating of the norm group in the corresponding category across the selected time segment. The mean and standard deviation of the goal ratings corresponding to each category of the norm group across the selected time segment may be calculated prior to the display of charts 1902, 1904, and 1906 (e.g., according to the method 1700 of FIG. 17). A scale 1912 may optionally be included at charts 1902, 1904, and 1906, and may represent goal ratings from 0 to 10.

In the example of chart 1902, the learner's average goal rating for Inspire Others over the 45-day time segment is 6.23, while the norm group mean goal rating in the corresponding category of Mobilizing/Influencing is 4.23 with a standard deviation of 2. Thus, the indicator 1924 is shown to be at the boundary between the light green section 1916 and the yellow section 1918 of the chart 1902 (e.g., consistent).

In the example of chart 1904, the learner's average goal rating for Work at Right Level over the 45-day time segment is 6.8, while the norm group mean goal rating in the corresponding category of Planning/Executing is 8.5 with a standard deviation of 1.5. Thus, the indicator 1926 is more than one standard deviation below the norm group mean goal rating and is shown to be in the red section 1922 of the chart (e.g., highly variable).

In the example of chart 1906, the learner's average goal rating for Grow Future Leaders over the 45-day time segment is 4, while the norm group mean goal rating in the corresponding category of Develop Talent is 5.0 with a standard deviation of 1.5. Thus, the indicator 1928 is between the norm group mean goal rating and one standard deviation below the norm group mean goal rating and is shown to be in the orange section 1920 of the chart (e.g., opportunity for improvement).

By being able to view their performance for a variety of goals compared to one or more selectable norm groups across one or more selectable time segments, a learner may gain insight regarding how their performance compares to that of their peers across multiple levels of a company. The learner may also be able to make determinations about the company culture (e.g., goal categories having higher averages may imply that those goal categories are given higher priority by the company).

It is contemplated that the present system may generate learning pods (i.e., groups of learners or users) to enable those users access to groups of other users within the system that may provide constructive feedback and reviews to assist a user in strengthen a good skill or goal or diminishing skills or attributes that the user considers bad. The pods may encompass or include system users that are considered “experts” within a particular field of research, business, science, etc. or users that are experts in particular skills, goals, or combinations of the same.

In generating these different types of learning pods, it should be understood that the system can analyze data comprising a particular user's defined goals (and the goal ratings—average or otherwise—associated with the same) as defined within the present system, as well as the goals and goal ratings of other users within the system. Additionally, the generation or identification of a particular pod of users may also involve the system analyzing biographical information of users, such as their age, sex, geographical location, spoken language, and the like. Pods that are developed to improve skills relating to physical activities and fitness may further group users based on physical attributes such as VO2max, lactate threshold, performance in different defined activities (e.g., 1500 meters time, swimming events) and the like. Such physical attributes may be received by the system from wearable devices configured to measure such physical attributes and event performance. The system may also analyze the professional biography of users in defining particular pods. A user's professional biography may include work and education history data, identifications of particular projects or types of work the user has undertaken or is current undertaking, and the like. All biographical data for a user of the present system may be provided through an appropriate user interface provided on a client 106 device.

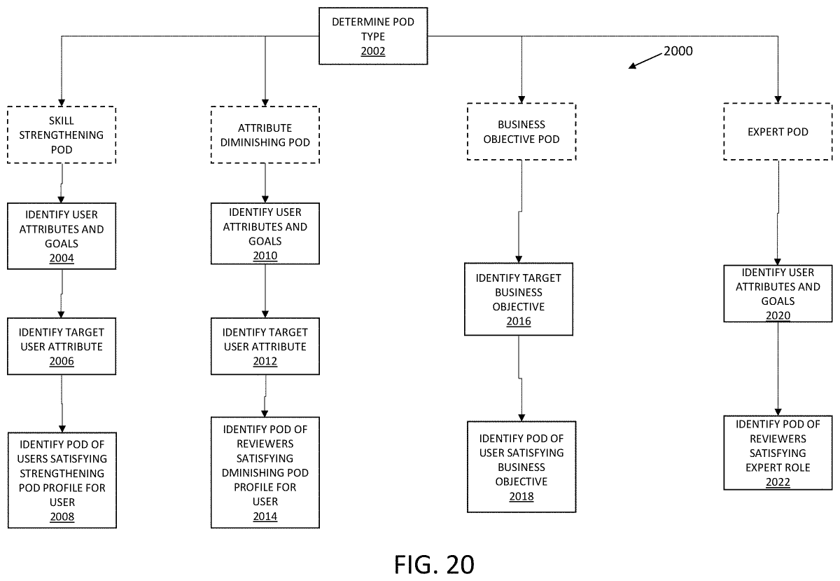

FIG. 20 is a flow chart depicting a process flow for performing a method 2000 for generating identifications of groups of users of the present system that may be connected to one another enabling the formation of a learning pod having target or desired attributes. Method 2000 may, for example, be performed by executing, on a computer processor included in a server computer system (e.g., servers 102 shown in FIG. 1), instructions stored on a non-transitory computer readable medium.

In an initial step 2002, a pod type is initially determined. The determination of the pod type may be made via instruction or other user inputs provided by the user that is initiating the pod creation via a suitable user interface device. Typically, when creating a new pod, the user that initiated new pod creation will be provided a listing (e.g., via client 106) of the available pod types. As shown in FIG. 20, the available pod types may include “SKILL STRENGTHENING POD,” “ATTRIBUTE DIMINISHING POD,” “BUSINESS OBJECTIVE POD,” and “EXPERT POD.” Each pod is associated with a different set of criteria that, when satisfied, enable the pod to achieve its desired outcome to assist the user in meeting their goals. It is contemplated that a user may belong to more than one learning pod at a time.

With reference to method 2000, if, in step 2002, the user selected SKILL STRENGTHENING POD, the method moves to step 2004 in which the user's attributes and goals are determined. That may involve the server computer system executing method 200 accessing a user account to determine the user's set of target goals as defined within a system user account. The server computer system at this time may also identify biographical information (both personal and professional) for the user to enable an appropriate learning pod of users to be established for the user.

In step 2006, a target attribute for the skill strengthening pod is determined. The target attribute may be selected via instruction or other user inputs provided by the user that is initiating the pod creation via a suitable user interface device. To receive the selection of the target attribute, the system may display a listing of the user's goals and goal attributes via a suitable user interface (e.g., displayed by client 106). The user can then designate one as being the skill (e.g., goal or goal attribute) to be strengthened by the present pod.

In step 2008, the server computer system identifies a group (i.e., “pod”) of users of the system that may be grouped together with the user to assist the user in strengthening that particular skill. Step 2008 may involve the server computer system identifying a set of users of the system that have each selected the same goal or skill for strengthening. Typically, because there can be a limited number of goals or skills defined within the present system, the number of users within the system that are trying to strengthen the same goal or skill will be relatively large (possibly hundreds or thousands of users or more). As such, step 2008 may involve selecting a smaller subset of users to place within the learning pod. Typically, this may involve identifying a pod of users where each user member of the pod shares biographical information with the user that is requesting generation of the pod.

As such, step 2008 may involve the server computer system identifying, of the group of users that all wish to strengthen or improve the same goal or skill, a pod (e.g., a group 20 users) that share biographical attributes. For example, the generated pod may include users that each belong to the same company or department within the company. The pod may also include users that are all located within a particular geographic region, belong to a particular department within a company and are located within a particular geographic region, or all users within an organization. In other cases, the pod may also include users that all work in a given industry.

In some cases, users may be selected for the pod based upon their personal biographical attributes matching those of other members in the pod. For example, users may be selected for a particular pod based upon the users having the same or similar (e.g., within a margin threshold) educational level, years in industry, and career phase, for example. In some embodiments, users may be selected for a pod based upon them sharing similar personal attributes such as age, sex, location, and language(s) spoken.

When selecting the users that are to be part of a skill strengthening pod, the server computer can optimize the user selection along any appropriate dimensions. In some embodiments, the server computer may require strict matching for all goals and goal ratings across all members of a particular pod, while requiring less strict matching between the member user's biographical (either professional or personal) attributes. In other cases, the server computer may not require strict matching between goals and ratings, while requiring strict matches between member user's biographical attributes (professional and/or personal).

Once a pod of users for the skill strengthening pod is identified, the server computer can transmit messages (e.g., to the client devices 106 of each user) notifying each user that the pod exists and inviting each user to join.

Once the users accept and join the pod, they can communicate with other users who belong to the same pod, request that one or more of those users operate as reviewers and benefit from ongoing interactions with those users.

If, however, in step 2002, the user selected ATTRIBUTE DIMINISHING POD, the method moves to step 2010 in which the user's attributes and goals are determined. That may involve the server computer system executing method 2000 accessing a user account to determine the user's set of target goals and goal ratings as defined within a system user account. The server computer system at this time may also identify biographical information (both personal and professional) for the user to enable an appropriate learning pod of users to be established for the user.

In step 2012, a target attribute (e.g., a tendency to interrupt, a lack of attention to detail, and the like) for the attribute diminishing pod is determined. The target attribute may be selected via instruction or other user inputs provided by the user that is initiating the pod creation via a suitable user interface device. To receive the selection of the target attribute, the system may display a listing of candidate attributes (e.g., derived from the user's goals and goal attributes) that the user may wish to diminish. The user can then select a specific attribute that the user wishes to be diminished by participating in the present pod.

In step 2014, the server computer system identifies a group (i.e., “pod”) of users of the system that may be grouped together with the user to assist the user in strengthening that particular skill. Step 2014 may involve the server computer system identifying a set of users of the system that have each selected the same attribute for diminishing. Typically, because there can be a limited number of goals or skills (i.e., attributes) defined within the present system, the number of users within the system that are trying to diminish the same goal or skill will be relatively large (possibly hundreds or thousands of users or more). As such, step 2014 may involve selecting a smaller subset of users to place within the learning pod. Typically, this may involve these a pod of users where each user member shares biographical information with the user that is requesting generation of the pod.

As such, step 2014 may involve the server computer system identifying, of the group of users that all share the same business objective, a pod (e.g., 20 users) that share biographical attributes. For example, the generated pod may include users that each belong to the same company or department within the company. The pod may also include users that are all located within a particular geographic region, belong to a particular department within a company and are located within a particular geographic region, or all users within an organization. In other cases, the pod may also include users that all work in a given industry. In some cases, users may be selected for the pod based upon their personal biographical attributes matching those of other members in the pod. For example, users may be selected for a particular pod based upon the users having the same or similar (e.g., within a margin threshold) educational level, years in industry, and career phase, for example. In some embodiments, users may be selected for a pod based upon them sharing similar personal attributes such as age, sex, location, and language(s) spoken.

When selecting the users that are to be part of an attribute diminishing pod, the server computer can optimize the user selection along any appropriate dimensions. In some embodiments, the server computer may require strict matching for all goals and goal ratings across all members of a particular pod, while requiring less strict matching between the member user's biographical (either professional or personal) attributes. In other cases, the server computer may not require strict matching between goals and ratings, while requiring strict matches between member user's biographical attributes (professional and/or personal).

Once a pod of users for the attribute diminishing pod is identified, the server computer can transmit messages (e.g., to the client devices 106 of each user) notifying each user that the pod exists and inviting each user to join.

Once the users join the pod, they can communicate with other users who belong to the same pod, request that one or more of those users operate as reviewers and benefit from ongoing interactions with those users.

If, however, in step 2002, the user selected BUSINESS OBJECTIVE POD, the method moves to step 2016 in which the business objective is identified. The business objective may be defined within the user data associated with the user that request the generation of the pod in step 2002. The business objective may be established by the user as a text input that describes a specific or general business objective. Specific business objectives may relate to particular projects within an organization (e.g., “execute on sales team 2022 strategic plan”, or “complete warehouse move from California to Arizona”) or more general business objectives for an organization (e.g., “grow sales by 10%” or “improve employee retention”).

The identification of the user's business objective may include the server computer accessing the user's account to determine the user's set business objective (or a list of business objectives that may be selected from). At this time, the server computer system may also identify biographical information (both personal and professional) for the user to enable an appropriate learning pod of users to be established for the user.

In step 2018, the server computer system identifies a group (i.e., “pod”) of users of the system that may be grouped together with the user to assist the user in achieving the selected business objective. Step 2018 may involve the server computer system identifying a set of users of the system that have each designated the same (or substantially similar) business objective. Step 2018 may further involve the server computer selecting, from the large set of users that may share the same business objective, a smaller number of users for the pod (e.g., about 20 users) where the users selected for the pod may each share similar biographical information (either personal or professional) with the user that is requesting generation of the pod.

As such, step 2018 may involve the server computer system identifying, of the group of users that all wish to diminish the same goal or skill, a pod (e.g., 20 users) that share biographical attributes. For example, the generated pod may include users that each belong to the same company or department within the company. The pod may also include users that are all located within a particular geographic region, belong to a particular department within a company and are located within a particular geographic region, or all users within an organization. In other cases, the pod may also include users that all work in a given industry.

In some cases, users may be selected for the pod based upon their personal biographical attributes matching those of other members in the pod. For example, users may be selected for a particular pod based upon the users having the same or similar (e.g., within a margin threshold) educational level, years in industry, and career phase, for example. In some embodiments, users may be selected for a pod based upon them sharing similar personal attributes such as age, sex, location, and language(s) spoken.

When selecting the users that are to be part of a business objective pod, the server computer can optimize the user selection along any appropriate dimensions. In some embodiments, the server computer may require strict matching for all business objectives across all members of a particular pod, while requiring less strict matching between the member user's biographical (either professional or personal) attributes. In other cases, the server computer may not require strict matching between business objectives, while requiring strict matches between member user's biographical attributes (professional and/or personal).

Once a pod of users for the business objective pod is identified, the server computer can transmit messages (e.g., to the client devices 106 of each user) notifying each user that the pod exists and inviting each user to join.

Once the users join the pod, they can communicate with other users who belong to the same pod, request that one or more of those users operate as reviewers and benefit from ongoing interactions with those users.

If, however, in step 2002, the user selected EXPERT POD, the method moves to step 2020 in which the user's attributes and goals are determined. That may involve the server computer system executing method 200 accessing a user account to determine the user's set of target goals as defined within a system user account. The server computer system at this time may also identify biographical information (both personal and professional) for the user to enable an appropriate learning pod of users to be established for the user.

In step 2022, the server computer system identifies a group (i.e., “pod”) of users of the system that are expert (i.e., have very high goal ratings for the user's goals identified in step 2020). Typically, because there can be a limited number of goals or skills defined within the present system, the number of users that will have high goal ratings in the same goals that the user has identified will be relatively large (possibly hundreds or thousands of users or more). As such, step 2022 may involve selecting a smaller subset of users to place within the learning pod. Typically, this may involve these a pod of users where each user member shares biographical information with the user that is requesting generation of the pod.

As such, step 2022 may involve the server computer system identifying, of the group of users that are experts in the goals that the user has selected, a pod (e.g., 20 users) that share biographical attributes with the user. For example, the generated pod may include users that each belong to the same company or department within the company. The pod may also include users that are all located within a particular geographic region, belong to a particular department within a company and are located within a particular geographic region, or all users within an organization. In other cases, the pod may also include users that all work in a given industry.

In some cases, users may be selected for the pod based upon their personal biographical attributes matching those of other members in the pod. For example, users may be selected for a particular pod based upon the users having the same or similar (e.g., within a margin threshold) educational level, years in industry, and career phase, for example. In some embodiments, users may be selected for a pod based upon them sharing similar personal attributes such as age, sex, location, and language(s) spoken.

When selecting the users that are to be part of an expert pod, the server computer can optimize the user selection along any appropriate dimensions. In some embodiments, the server computer may require strict matching for all goals and goal ratings across all members of a particular pod, while requiring less strict matching between the member user's biographical (either professional or personal) attributes. In other cases, the server computer may not require strict matching between goals and ratings, while requiring strict matches between member user's biographical attributes (professional and/or personal).

Once a pod of users for the expert pod is identified, the server computer can transmit messages (e.g., to the client devices 106 of each user) notifying each user that the pod exists and inviting each user to join.

Once the user that executed step 2002 joins the expert pod, the user can communicate with other users (i.e., the experts) who belong to the same pod, request that one or more of those users operate as reviewers and benefit from ongoing interactions with those expert users.

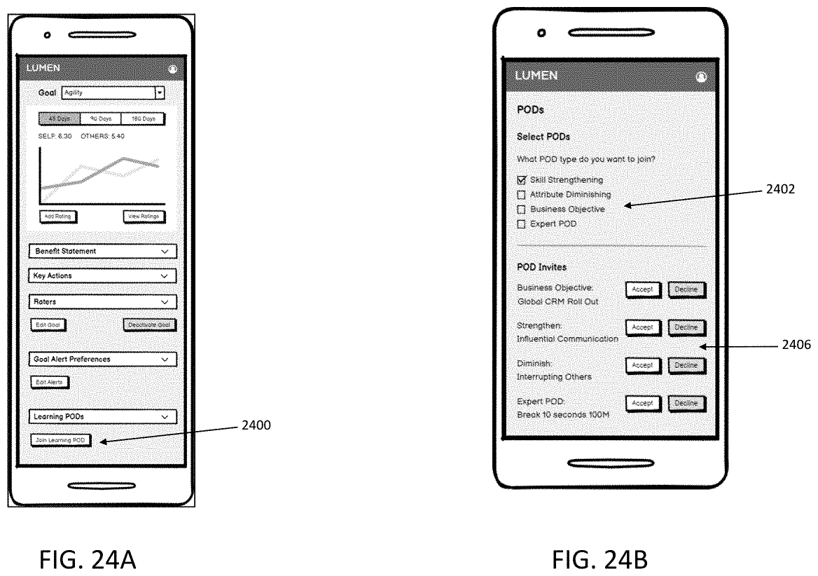

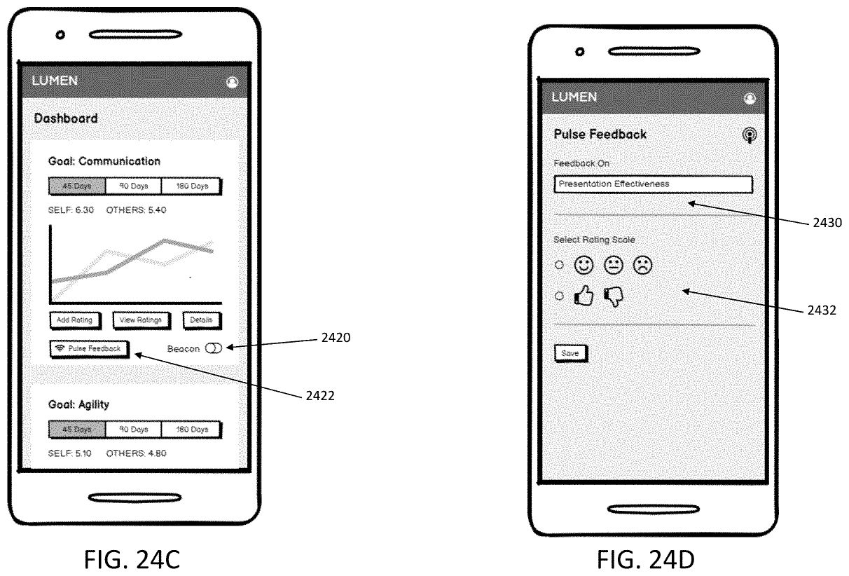

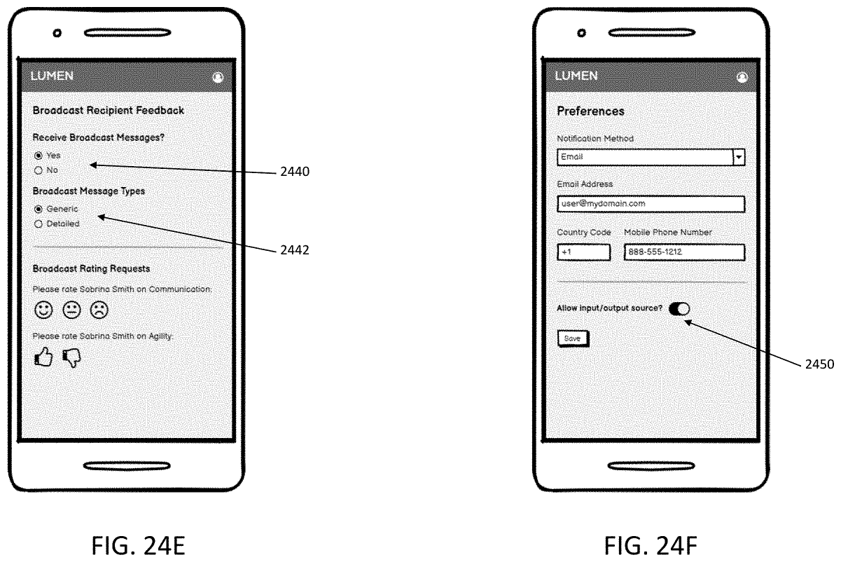

FIGS. 24A and 24B depict screenshots showing user interfaces that may be displayed on a user device (e.g., client 106) to implement part of all of the functionality described with respect to the method of FIG. 20 and the generation of learning pods that collect reviews and feedback from users of the present system. FIG. 24A depicts a user interface that may be displayed when a user wishes to define the user's goals, and preferences. Using the user interface of FIG. 24A, the user can define various attributes of a particular goal. Then, by activating user interface button 2400, the user can trigger the create pod screen in which the user can request creation of a pod to strengthen or diminish a particular skill in accordance with the define goal. FIG. 2B depicts a user interface that the user may utilize to create such a new pod. The interface enables the user to select the type of pod 2402 (e.g., corresponding to step 2002 of method 2000). The interface also provides a listing 2404 of pods that have previously been created and to which the user has been invited. The user can accept or reject those invitations using the approach user interface buttons.

In some embodiments of the present system, a user may wish to use the present system to trigger or request on-the-fly rater feedback in real-time and regarding a specific real-world event. For example, a learner may be about to give a presentation or sales pitch and may wish to solicit feedback and reviews from people in the room and attending the event.

In that case, the user may execute a client application (e.g., running on client 106) to trigger a local and real-time rater event. In one embodiment, the user can trigger the local and real-time rater event by providing an appropriate user input to the client 106 running the client application. Once triggered, the client application can cause the client 106 to transmit a rater request to the client 106 devices of other users of the system that are in proximity to the user. If the other users meet particular criteria, their client devices 106, upon receipt of the local and real-time rater request execute their own client applications causing the client devices 106 to generate a user interface including a prompt as they the users to provide appropriate rater feedback.

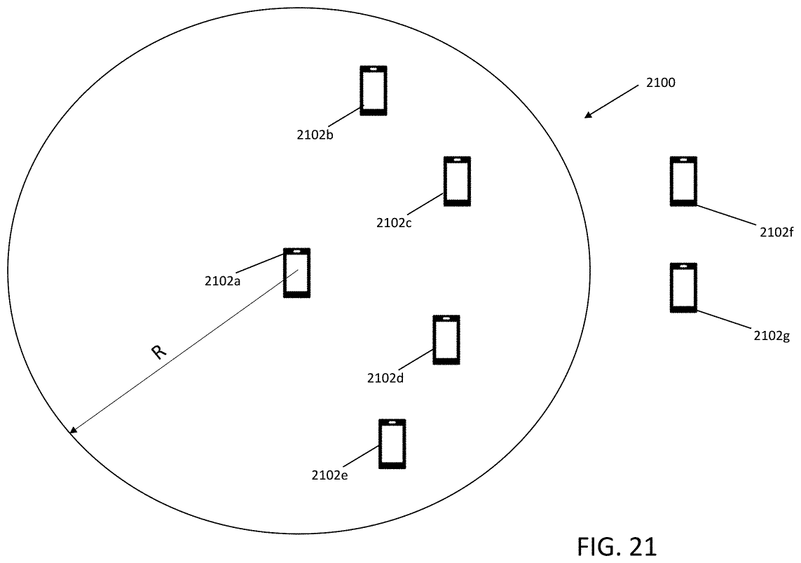

To illustrate, FIG. 21 depicts an environment 2100 in which a user or learner of the present system may desire local and real-time feedback from a number of rater (e.g., users) of the present system. As illustrated in FIG. 21, the user soliciting feedback operates a client device 2102a (e.g., client 106). A number of other users of the system operate their own client devices 2102b-2102g within environment 2100.

The user of device 2102a wishes to solicit review and feedback from users of the system that are within a particular proximity to the user. For example, the user may be giving a presentation or may be participating in a meeting (e.g., a large board meeting) in which a number of other users of the system may be present. The user may wish to solicit feedback from those particular users. As such, the user of device 2102a may, in accordance with this disclosure, cause the device to transmit a request for review or feedback to other devices (i.e., device 2102b-2102e) that are within a particular geographic range (e.g., within a region defined by a circle positioned around device 2102a having a radius of R).

Devices outside that radius (e.g., devices 2102f and 2102g) are defined as being too far away from device 2102a (and, presumably, the user of device 2102a) and are therefore unlikely to be operated by users who are able to make direct observations of and provide useful feedback on the user's performance.

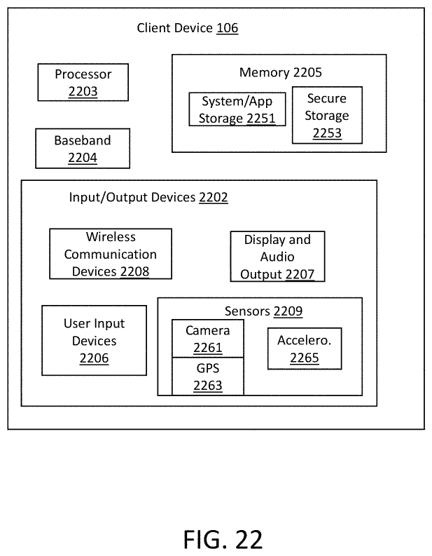

To further describe the operation of the local and real-time rater capabilities of the present system, further description of the functional components of devices 2102 and client 106 is provided. Specifically, FIG. 22 is a block diagram illustrating example functional components of a device 2102 (i.e., client 106). It is noted that not every embodiment of the invention requires the entire architecture as illustrated in FIG. 22. As shown in FIG. 22, client 106 may include input-output devices 2202, processing circuitry including an application processor 2203 and a wireless communication processor 2204, and memory device 2205. As depicted, memory device 2205 is segmented to include general system and application storage 2251. Storage 2251 may be non-secure and may include storage locations within memory device 2205 that are generally accessible to all or most applications running on client 106. Memory device 2205 also includes secure storage 2253. Secure storage 2253 may include an encrypted or otherwise protected portion of memory device 2205.

Input-output devices 2202 allow client 106 to receive input data from various user interfaces and generate human-perceptible outputs (e.g., audio output or display outputs) for review by a user of client 106. Input-output devices 2202 may include user input-output devices 2206 (e.g., keyboards, display or touch screens, microphones, etc.), display and audio devices 2207, wireless communications subsystem 2208, and sensors 2209. Sensors 2209 may include sensor devices configured to measure a physical attribute of client 106 or other physical signals (e.g., light, sound, temperature, etc.). Sensors 2209 include one or more cameras 2261 (e.g., front and rear facing cameras), GPS unit 2263, and accelerometers 2265. Using the user input-output devices 2206 such as a touch screen and physical buttons, the user of client 106 may supply commands to control the operations of client 106.

To prevent unauthorized users' access to information in the client 106, the client 106 may be locked. While the client 106 is in a locked mode, if the client 106 detects that commands are received via the user input-output device 2206, the display panel may display a locked screen. In some embodiments, limited access to certain applications on client 106 may be provided without entering password or biometrics.

Input-output devices 2202 may also include wireless communications subsystem 2208 having communications circuitry such as radio frequency (RF) transceiver circuitry, antennas, etc. Wireless communications subsystem 2208 may include cellular, BLUETOOTH, ZIGBEE, and WIFI communication devices or any other devices configured to communicate via wireless transmission and reception of data.

In one embodiment, a microphone port and speaker ports may be coupled to the communications circuitry to enable the user to participate in wireless telephone or video calls that allow or support wireless voice communications. A wireless voice call that uses the wireless communications subsystem 2208 may be a voice-only call or a voice-and-video call that has been placed to or received from any one of a variety of different wireless communications networks and in accordance with any one of several different call protocols. These include: a cellular mobile phone network (e.g., a Global System for Mobile communication (GSM) network and an LTE network), including current 2G, 3G and 4G networks; and an IEEE 802.11 network (Wi-Fi or Wireless Local Area Network, WLAN. Wireless communications subsystem 2208 are configured to initiate and participate in VoIP calls over any suitable IP network.

The processing circuitry of client 106 includes an application processor 2203 and a wireless communication processor 2204 that are communicatively coupled to each other via an internal bus. The baseband processor 2204 may be any kind of wireless processor, such as for example, cellular processor, a Wi-Fi processor, a Bluetooth processor, etc. Application processor 2203 may be any kind of general-purpose processor such as a microprocessor, a microcontroller, a digital signal processor, or a central processing unit, and other needed integrated circuits. The term “processor” may refer to a device having two or more processing units or elements, e.g., a CPU with multiple processing cores. The application processor 2203 may be used to control the operations of client 106. For example, the processing circuitry may be coupled to the communications circuitry and execute software to control the wireless communications functionality of client 106 (e.g., initiating an outgoing call or answering an incoming call). In some cases, a particular function may be implemented as two or more pieces of software that are being executed by different hardware units of a processor.

In one embodiment, the processing circuitry is also coupled to memory 2205. Memory 2205 and, in an embodiment, system/app storage 2251 of memory 2205, stores instructions (e.g., software; firmware) which may be executed by the application processor 2203 or baseband processor 2204. For example, the application processor 2203 and memory 2205 are used to run various mobile applications executed by client. Memory 2205 may include one or more different types of storage such as hard disk drive storage, nonvolatile memory, and volatile memory such as dynamic random-access memory.

During operation of client 106, processor 2203 can access sensors 2209 to receive data therefrom. Sensors 2209 are generally configured to monitor or measure one or more physical attribute of client 106 or conditions and/or signals received by sensors 2209. For example, processor 2203 can access camera(s) 2261 to receive a stream of visual data captured by image or light sensors within the various camera(s) 2261 of mobile device. Similarly, processor 2203 can access GPS sensor 2263 to receive a stream of current GPS coordinates or other location data of client 106. Processor 2203 is configured to access accelerometer 2265 to receive a stream of data from the accelerometer 2265 specifying a current position, orientation, and/or movement of mobile device. Accelerometer 2265 may be configured to detect its movement to determine various components of motion. The components of motion may include forward (roll axis), vertical (yaw axis), side (pitch axis) and acceleration in the x, y, and z directions. Accelerometer 2265 may output a sensor signal that represents any one or more such components, to the application processor 2203. Processor 2203 is configured to receive streams of data from each sensor 2209 of mobile device 2203.

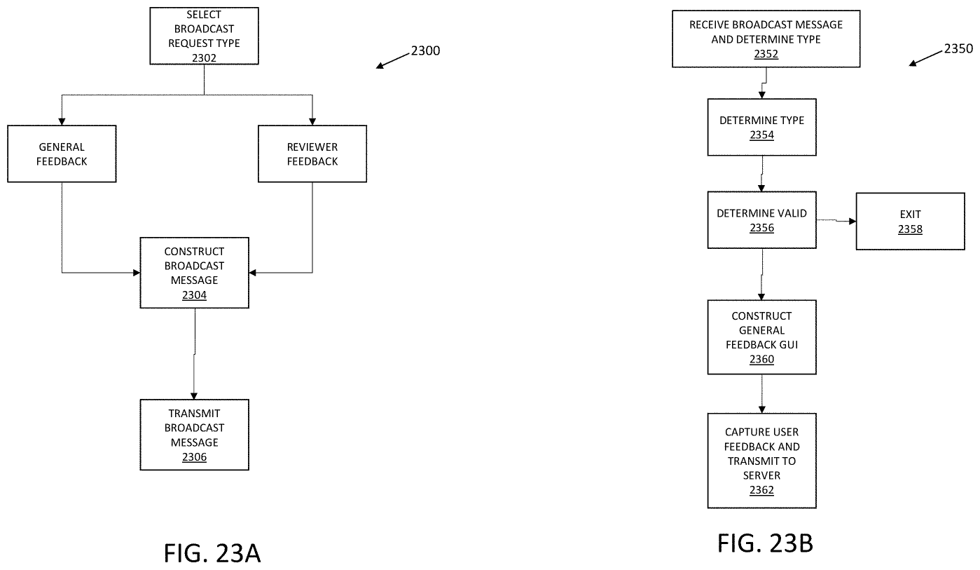

FIG. 23A is a flow chart depicting a method 2300 that a user of device 2012a may use to request feedback from nearby raters. In step 2302 the user may select a type of broadcast message to transmit to nearby raters. In this embodiment, the client application running on device 2102a enables the user to transmit two types of request broadcast messages—first, a request for general feedback, and second, a request for specific feedback. In an embodiment, the request for specific feedback may be limited to users that are specifically enrolled as “reviewers” in the present system. Alternatively, the request for specific feedback may be transmitted to all users of the system. In this disclosure an example of the specific feedback request is described in which the request is limited to reviewer-type users in the system. But it should be understood that the request could be sent to all users of the present system.

The request for general feedback may be intended for all users of the system, whether they are enrolled as reviewers or not. This request for feedback may only request simplified or high-level feedback that may not be burdensome for a user to provide. For example, this general feedback may only comprise a user select one of three options—positive feedback, neutral feedback, and negative feedback as part of their response feedback. Conversely, the second request, for reviewer-specific feedback, may request more detailed and comprehensive feedback that is only suitable for being provided by users of the system that are enrolled as reviewers. This form of feedback may be more burdensome and nuanced and so may be limited to reviewers only.

In step 2304 device 2102a constructs an appropriate broadcast message. In an embodiment, the broadcast message encodes information provided by the user to assist recipients in knowing which user they are reviewing. For example, the broadcast message may encode the user's name, a brief description of the event or work product that the user wishes to be reviewed, as well as an indication of the level of review that the user wishes to receive. The user may also specify the radius distance R defining the region in which a rater should be located in order to be authorized to provide a review or feedback. In other embodiments, the distance R may be set automatically or may be a fixed value. In an embodiment, to assist in the determination of whether a recipient is within range to receive a rater request, the location of device 2102a (e.g., determined via signals received from GPS sensor 2263) may be encoded into the broadcast.

In still other embodiments, rather than relying on GPS location data to determine whether a rater is in range, the range of broadcast message can be limited by the communication protocol. For example, BLUETOOTH communication protocols tend to have a limited transmission range compared to WIFI and cellular transmissions. As such, if the broadcast message is transmitted via BLUETOOTH, the limited range of BLUETOOTH may ensure that only recipient devices 2102 that are in relatively proximity to device 2102a (e.g., within radius R) receive the broadcast message and are able to solicit feedback.

Additionally, the level of feedback that the requester is requesting (e.g., general or reviewer-level feedback) may be encoded into the broadcast message.

Once generated, the broadcast message is transmitted in step 2306 via a suitable wireless communication protocol as enabled by wireless communication subsystem 2208 of device 2102a.

FIGS. 24C-24D depict a sequence of user interfaces that may be utilized by a user of the present system to request feedback from system users (e.g., users, raters, and/or reviewers) that are in the vicinity. Referring to FIG. 24C, which displays a general desktop view, the user can trigger beacon broadcasting by operating the toggle switch 2420. With the toggle switch 2420 in a first position, no broadcast messages are transmitted. With the toggle switch 2420 in a second position, however, the broadcast messages are transmitted (e.g., in accordance with the method depicted in FIG. 23A). If the user wishes to transmit requests for general (also referred to herein as “pulsed”) feedback, the user can activity button 2422 to display the settings screen for general or pulse feedback. FIG. 24D displays a user interface for configuring the pulse or general feedback requests. Specifically, text box 2430 enables a user to describe the specific thing they would like feedback on. The user can also select the type of feedback 2432 that should be requested via the broadcast message. With those selections made the user can trigger a broadcast request asking for general or pulse feedback (e.g., in accordance with steps 2304 and 2306 of FIG. 23A).

FIG. 23B is a flow chart depicting a method 2350 that a recipient device 2102 (e.g., one of devices 2102b-2102e) that is within range of the transmitting device 2102a may utilize to enable a user or reviewer to provide feedback.

In step 2352 the broadcast message (e.g., the broadcast message transmitted by device 2102a in step 2306 of FIG. 23A is received. In step 2354, the recipient device processes the received broadcast message to determine the type of feedback that is being requested (e.g., general feedback or reviewer-specific feedback). In step 2356, the recipient device determines whether the request for feedback is valid. This determination my involve two steps. First, if the request type determined in step 2354 is for reviewer-specific feedback and the user is not a reviewer within the system (e.g., the user is only a learner), the recipient device may determine that the received request is invalid for the recipient device's user and the received request may be ignored (with the method moving to step 2358.

In a second confirmation step, the recipient device may determine whether the recipient device is within range (e.g., within the radius distance R specified in the broadcast message) to process the broadcast message. This may involve the recipient device determining a distance between a location of the recipient device (e.g., as determined via data received from a GPS sensor in the recipient device) and the location of the requesting device (e.g., as determined by the location of the requesting device as encoded into the broadcast message). The recipient device can then compare that distance to the radius distance R that was encoded into the broadcast message. If the distance between the requesting device and the recipient device is greater than the radius distance R, the requesting device may determine that the received broadcast request is invalid for the recipient device's user and the received request may be ignored (with the method moving to step 2358.

In some embodiments, the recipient device, as part of its validity check may also take steps to confirm that the user transmitting the broadcast request (e.g., via device 2102a) and the recipient are attending the same event before determining that the broadcast request is valid. In some embodiments, this may involved the recipient device analyzing stored calendar data to determine whether an event is on the calendar for the current time in which the recipient and requester are both listed as attendees.

If the broadcast request is determined to be valid, the method moves to step 2360 in which the recipient device generates an appropriate user interface form (e.g., a suitable data collection form or UI enabling an operator to provide feedback via a display screen), where the configuration of the user interface form is determined by the type of the request (e.g., general feedback or reviewer-specific) encoded into the request broadcast in step 2306 of FIG. 23A.

On generated, in step 2362 the user interface is displayed. Feedback provided by the user into the user interface can then be transmitted to the system (e.g., server 102, FIG. 1) for storage and analysis. At that time the captured feedback can also be transmitted to device 2302a for reviewer by the user.

FIG. 24E depicts a user interface that enables a user of a device (e.g., a device configured to receive the broadcast message transmitted in accordance with the message of FIG. 23A, such as devices 2102b-2102-e) to filter or control the types of broadcast rating requests that are accepted. Specifically, the interface allows a user to specify whether they want to receive broadcast request using user interface element 2440. Then using element 2442, the user can specify the types of broadcast requests that they are will to accept. These setting will be used to determine whether a broadcast request received by a recipient device is processed to solicit review by the user (e.g., step 2356 of the method of FIG. 23B).

FIG. 24F depicts a user interface in which a user can operate a toggle switch 2450 to determine whether the application should have access to external data sources, such as data stored on wearable devices, blood pressure monitors, and the like.

In some aspects, the techniques described herein relate to a system, including: a first mobile device, including: a first wireless communication subsystem, a first global positioning system (GPS) sensor, and a first processor configured to execute instructions stored on a first non-transitory computer readable storage medium for: receiving from a first user interface device of the first mobile device, a review type indicator; accessing the first GPS sensor to determine a first location of the first mobile device; encoding the review type indicator, the first location of the first mobile device, and a radius distance indicator into a broadcast message; and transmitting, using the first wireless communication subsystem, the broadcast message; a second mobile device, including: a second wireless communication subsystem, a second GPS sensor, and a second processor configured to execute instructions stored on a second non-transitory computer readable storage medium for: receiving, using the second wireless communication subsystem, the broadcast message; processing the broadcast message to determine the review type indicator, the first location of the first mobile device, and the radius distance locator; accessing the GPS sensor to determine a second location of the second mobile device; determine that a distance between the first location and the second location is less than the radius distance indicator; display, on a second user interface of the second mobile device, a form to capture feedback, wherein a content of the form is determined by the review type indicator; capturing user input provided into the form by a user of the second mobile device; and transmitting, using the second wireless communication subsystem, the user input; and a server device, including: a third processor configured to execute instructions stored on a third non-transitory computer readable storage medium for: receiving the user input; and storing the user input into a database, wherein the user input is stored in association with an identifier of a user of the first mobile device.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

1. A system, comprising:
a first mobile device, including:
a first wireless communication subsystem,
a first global positioning system (GPS) sensor, and
a first processor configured to execute instructions stored on a first non-transitory computer readable storage medium for:
receiving from a first user interface device of the first mobile device, a review type indicator;
accessing the first GPS sensor to determine a first location of the first mobile device;
encoding the review type indicator, the first location of the first mobile device, and a radius distance indicator into a broadcast message; and
transmitting, using the first wireless communication subsystem, the broadcast message;
a second mobile device, including:
a second wireless communication subsystem,
a second GPS sensor, and
a second processor configured to execute instructions stored on a second non-transitory computer readable storage medium for:
receiving, using the second wireless communication subsystem, the broadcast message;
processing the broadcast message to determine the review type indicator, the first location of the first mobile device, and the radius distance locator;
accessing the GPS sensor to determine a second location of the second mobile device;
determine that a distance between the first location and the second location is less than the radius distance indicator;
display, on a second user interface of the second mobile device, a form to capture feedback, wherein a content of the form is determined by the review type indicator;
capturing user input provided into the form by a user of the second mobile device; and
transmitting, using the second wireless communication subsystem, the user input; and
a server device, including:
a third processor configured to execute instructions stored on a third non-transitory computer readable storage medium for:
receiving the user input; and
storing the user input into a database, wherein the user input is stored in association with an identifier of a user of the first mobile device.

2. The system of claim 1, wherein the user input includes at least a goal rating.

3. The system of claim 1, wherein the third processor is configured to execute instructions stored on the third non-transitory computer readable storage medium for:
scanning a plurality of goal ratings stored in a database at the server device, the plurality of goal ratings corresponding to evaluations of goals of one or more learners;
identify that a predefined condition has been met based on the plurality of goal ratings; and
electronically send, via at least one electronic communication network, at least one alert to at least one client computer device based on identifying that the predefined condition has been met.

4. The system of claim 3, wherein the third processor is configured to execute instructions stored on the third non-transitory computer readable storage medium for:
identifying that no goal ratings have been submitted by a first rater for a goal of a learner of the one or more learners for a period of time exceeding a predefined inactivity threshold value;
generating first, second, and third inactivity alerts;
electronically sending the first inactivity alert to a first client computer device associated with a first user account of the learner;
electronically sending the second inactivity alert to a second client computer device associated with a second user account of a reviewer; and
electronically sending a third inactivity alert to a third client computer device associated with a third user account of a coach.

5. The system of claim 3, wherein the third processor is configured to execute instructions stored on the third non-transitory computer readable storage medium for:
determining that an observation note has been submitted with a goal rating of the plurality of goal ratings, the goal rating corresponding to a goal of the learner of the one or more learners;
generating first and second observation alerts;
electronically sending the first observation alert to a first client computer device associated with a first user account of the learner; and
electronically sending the second observation alert to a second client computer device associated with a second user account of a coach.

6. The system of claim 3, wherein the third processor is configured to execute instructions stored on the third non-transitory computer readable storage medium for:
identifying a maximum goal rating of a first set of goal ratings submitted by a second rater within a predetermined time period for a goal of a learner;
identifying a minimum goal rating of a second set of goal ratings submitted by the learner for the goal within the predetermined time period;
determining a rating differential by calculating a difference between the minimum goal rating and the maximum goal rating;
determining that the rating differential exceeds a predefined delta threshold value;
generating first and second delta alerts;
electronically sending the first delta alert to a first client computer device associated with a first user account of the learner; and
electronically sending the second delta alert to a second client computer device associated with a second user account of a coach.

7. The system of claim 3, wherein the third processor is configured to execute instructions stored on the third non-transitory computer readable storage medium for:
calculating an average goal rating value by averaging all goal ratings submitted by raters over a predefined progress assessment time period for a goal of a learner;
calculating a progress percentage corresponding to the average goal rating value divided by a target goal rating value set by the learner;
determining that the progress percentage exceeds a predefined progress threshold value;
generating first, second, and third progress alerts;
electronically sending the first progress alert to a first client computer device associated with a first user account of the learner;
electronically sending the second progress alert to a second client computer device associated with a second user account of the reviewer; and
electronically sending the third progress alert to a third client computer device associated with a third user account of a coach.

8. The system of claim 3, wherein the third processor is configured to execute instructions stored on the third non-transitory computer readable storage medium for:
scanning the plurality of goal ratings to identify to identify a set of goal ratings corresponding to an unprocessed predefined group of learners of a set of predefined groups of learners;
calculating a first mean and a first standard deviation of a first subset of goal ratings of the set of goal ratings, the first subset of goal ratings corresponding to a first predefined category;
calculating a second mean and a second standard deviation of a second subset of goal ratings of the set of goal ratings, the second subset of goal ratings corresponding to a second predefined category;
generating a first chart that is divided into a first plurality of sections, the first plurality of sections corresponding to first goal rating ranges that are bounded based on the first mean and the first standard deviation, the first chart including a first indicator corresponding to a first average goal rating for a first goal of the learner over a selected time segment, the first goal corresponding to the first predefined category;
generating a second chart that is divided into a second plurality of sections, the second plurality of sections corresponding to second goal rating ranges that are bounded based on the second mean and the second standard deviation, the second chart including a second indicator corresponding to a second average goal rating for a second goal of the learner over the selected time segment, the second goal corresponding to the second predefined category; and
instructing a first client computer device associated with a user account of a learner to display the first chart and the second chart.

9. A method comprising:
scanning, by a processor of a server device, a plurality of goal ratings stored in a database at the server device, the plurality of goal ratings corresponding to evaluations of goals of one or more learners;
identifying, by the processor, that a predefined condition has been met based on the plurality of goal ratings; and
electronically sending, by the processor via at least one electronic communication network, at least one alert to at least one client computer device based on identifying that the predefined condition has been met.

10. The method of claim 9, wherein identifying that the predefined condition has been met comprises identifying that no goal ratings have been submitted by a first rater for a goal of a learner of the one or more learners for a period of time exceeding a predefined inactivity threshold value, and wherein electronically sending the at least one alert comprises:
generating first, second, and third inactivity alerts;
electronically sending the first inactivity alert to a first client computer device associated with a first user account of the learner;
electronically sending the second inactivity alert to a second client computer device associated with a second user account of a reviewer; and
electronically sending a third inactivity alert to a third client computer device associated with a third user account of a coach.

11. The method of claim 9, wherein identifying that the predefined condition has been met comprises determining that an observation note has been submitted with a goal rating of the plurality of goal ratings, the goal rating corresponding to a goal of a learner of the one or more learners, and wherein electronically sending the at least one alert comprises:
generating first and second observation alerts;
electronically sending the first observation alert to a first client computer device associated with a first user account of the learner; and
electronically sending the second observation alert to a second client computer device associated with a second user account of a coach.

12. The method of claim 9, wherein identifying that the predefined condition has been met comprises:
identifying a minimum goal rating of a first set of goal ratings submitted by a second rater within a predetermined time period for a goal of a learner;
identifying a maximum goal rating of a second set of goal ratings submitted by the learner for the goal within the predetermined time period;
determining a rating differential at least by calculating a difference between the maximum goal rating and the minimum goal rating; and
determining that the rating differential exceeds a predefined delta threshold value.

13. The method of claim 12, wherein electronically sending at least one alert comprises:
generating first and second delta alerts;
electronically sending the first delta alert to a first client computer device associated with a first user account of the learner; and
electronically sending the second delta alert to a second client computer device associated with a second user account of a coach.

14. The method of claim 9, wherein identifying that the predefined condition has been met comprises:
calculating an average goal rating value by averaging all goal ratings submitted by raters over a predefined progress assessment time period for a goal of a learner;
calculating a progress percentage corresponding to the average goal rating value divided by a target goal rating value set by the learner; and
determining that the progress percentage exceeds a predefined progress threshold value.

15. The method of claim 14, wherein electronically sending the at least one alert comprises:
generating first, second, and third progress alerts;
electronically sending the first progress alert to a first client computer device associated with a first user account of the learner;
electronically sending the second progress alert to a second client computer device associated with a second user account of the reviewer; and
electronically sending the third progress alert to a third client computer device associated with a third user account of a coach.

16. The method of claim 9, further comprising:
scanning, by the processor, the plurality of goal ratings to identify a set of goal ratings corresponding to an unprocessed predefined group of learners of a set of predefined groups of learners;
calculating, by the processor, a first mean and a first standard deviation of a first subset of goal ratings of the set of goal ratings, the first subset of goal ratings corresponding to a first predefined category;
calculating, by the processor, a second mean and a second standard deviation of a second subset of goal ratings of the set of goal ratings, the second subset of goal ratings corresponding to a second predefined category;
generating, by the processor, a first chart that is divided into a first plurality of sections, the first plurality of sections corresponding to first goal rating ranges that are bounded based on the first mean and the first standard deviation;
generating, by the processor, a second chart that is divided into a second plurality of sections, the second plurality of sections corresponding to second goal rating ranges that are bounded based on the second mean and the second standard deviation; and
instructing, by the processor, a first client computer device associated with a user account of a learner to display the first chart and the second chart.

17. The method of claim 16, wherein the first chart includes a first indicator corresponding to a first average goal rating for a first goal of the learner over a selected time segment, wherein the second chart includes a second indicator corresponding to a second average goal rating for a second goal of the learner over the selected time segment, wherein the first goal corresponds to the first predefined category, and wherein the second goal corresponds to the second predefined category.
